(19) United States
(12) Patent Application Publication
(10) Pub. No.: US 2016/0048875 A1
(43) Pub. Date: Feb. 18, 2016

(54) ENTITY BASED SEARCH ADVERTISING WITHIN A MODULAR SEARCH OBJECT FRAMEWORK

(71) Applicant: Yahoo! Inc., Sunnyvale, CA (US)

(72) Inventors: Sophia Thitirat Perl, San Jose, CA (US); Conrad Wai, San Francisco, CA (US); Michael Eric Plasmeier, Mountain View, CA (US); Andrew Poon, San Francisco, CA (US); Enrique Andres Munoz Torres, Mountain View, CA (US); Tingyi Wu, Sunnyvale, CA (US)

(73) Assignee: Yahoo! Inc., Sunnyvale, CA (US)

(21) Appl. No.: 14/457,985

(22) Filed: Aug. 12, 2014

(51) Int. Cl. G06Q 30/02; G06F 17/30

(52) U.S. Cl. CPC G06Q 30/0256; G06F 17/30864

(57) ABSTRACT

A modular search object framework can provide monetization of entity based content. Such a framework can include circuitry configured to manually or automatically link monetized search terms with entities, so that the entities can be monetized without additional bids on the entities. Once the framework generates such links, advertisers may continue to bid on search terms, and create new links or change initial links. Also, through the framework advertisers may bid on an entity that can encompass a set of associated search terms. For example, instead of bidding on a great number of search terms, an advertiser can bid on a few entities that include at least a majority of the associated search terms. With such functionality, the workload of the advertiser can be greatly reduced.

### PRIORITY

The present application is related to U.S. patent application Ser. No. 14/277,964, titled “ENTITY SPONSORSHIP WITHIN A MODULAR SEARCH OBJECT FRAMEWORK”, filed May 15, 2014, and U.S. patent application Ser. No. 14/266,548, titled “MODULAR SEARCH OBJECT FRAMEWORK”, filed Apr. 30, 2014, which are both incorporated by reference herein.

### BACKGROUND

This application relates to sponsorship and monetization of entity based content (such as monetized entity search results and associated graphical user interfaces).

It is common for users to enter an online query for content including one or more search terms. From execution of such a query, sponsored and non-sponsored search results may be provided on a results page that gives lists of links with titles and some description of the linked contents. In the sponsored search results, links are usually monetized.

Increasingly, users are executing searches on mobile devices, such as smartphones or tablets. The common technique of providing lists of results is not well adapted to the particular constraints of a mobile device. There is, therefore, a set of engineering problems to be solved in order to provide search results to users that are well adapted to mobile devices or mobile device interfaces to other devices (such as televisions). Also, the monetization of search results adapted to mobile devices or mobile device interfaces to other devices brings up technical problems to be solved as well. For example, conventional sponsored ads in the mobile context may be intrusive to the user experience.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can provide aspects of a modular search object framework, such as entity sponsorship.

FIG. 2 illustrates example operations of example circuitry of an example system that can provide aspects of the module search object framework. In an example, the operations can be performed by circuitry of a server, such as the modular search framework server 116 illustrated in FIG. 1.

FIG. 3a illustrates an example graphical user interface (GUI) configured to provide an interface for bidding on search terms.

FIG. 3b illustrates an example GUI configured to link a search term to an entity search result object.

FIG. 3c illustrates an example GUI configured to provide an interface for bidding on a link between a search term and an entity search result object.

FIG. 3d illustrates an example GUI configured to provide an interface for additional bidding on a link between a search term and an entity search result object.

FIG. 3e illustrates an example GUI configured to provide an interface for selecting and then possibly bidding on entities at a later stage.

FIG. 3f illustrates an example GUI configured to provide an interface for selecting and then possibly bidding on search terms at a later stage.

FIG. 3g illustrates an example GUI configured to provide an interface for selecting and then possibly bidding on search terms and entities at a later stage.

FIG. 4 illustrates a block diagram of example circuitry of a server of an example system that can provide aspects of the module search object framework, such as a modular search framework server 116 illustrated in FIG. 1.

FIGS. 5-7 illustrate block diagrams of example entity sub-circuitries of a server of an example system that can provide aspects of the module search object framework, such as a modular search framework server 400 illustrated in FIG. 4.

FIG. 8 is a block diagram of an example electronic device that can implement aspects of and related to an example system that can provide aspects of the module search object framework, such as a modular search framework server 400 illustrated in FIG. 4.

FIG. 9 illustrates a block diagram of example circuitry of a client device of an example system that can provide aspects of the module search object framework, such as the audience client device 124 of the system illustrated in FIG. 1.

FIG. 10 is a block diagram of an example electronic device that can implement aspects of and related to an example system that can provide aspects of the module search object framework, such as the audience client device 124 or the advertiser client device 122 illustrated in FIG. 1.

FIG. 11a illustrates displayed entity and non-entity search result objects and search suggestion objects on an example page view rendered by an example client-side application, such as a mobile web browser. The example client-side application can be executed on any one of the client devices illustrated in FIG. 1, such as the audience client device 124.

FIG. 11b illustrates an example expanded and displayed sponsored entity search result object associated with Barack Hussein Obama II the politician on an example page view rendered by the example client-side application of FIG. 11a. Specifically, this depiction of the expanded object includes an example summary section rendered by example summary circuitry of the modular search object framework. Within the framework, Barack Hussein Obama II the politician entity is a type of person entity.

FIG. 12a illustrates the example displayed entity search result object of FIG. 11b. Specifically, this depiction of the displayed object includes multiple interactive sections rendered by respective circuitry of the modular search object framework. Some of the sections and objects within FIGS. 12a-15b are sponsored.

FIG. 12b illustrates the example displayed entity search result object of FIG. 11b overlapped by an example image based search results section and an example webpage based search results section rendered by respective circuitry of the modular search object framework.

FIG. 13a illustrates the example displayed entity search result object of FIG. 11b overlapped by an example image based search results section rendered by respective circuitry of the modular search object framework.

FIG. 13b illustrates the example displayed entity search result object of FIG. 11b overlapped by an example map based search results section rendered by respective circuitry of the modular search object framework.

FIG. 14a illustrates an example expanded and displayed sponsored entity search result object on an example page view rendered by the client-side application. Specifically, this depiction of the displayed object includes an example summary section rendered by example summary circuitry of the modular search object framework.

FIG. 14b illustrates the example displayed entity search result object in FIG. 14a. However, this depiction of the displayed object includes an example summary section and an example predicted answer section rendered by respective circuitry of the modular search object framework.

FIG. 15a illustrates an example expanded and displayed sponsored entity search result object associated with a place. Specifically, this depiction of the displayed object associated with a place includes a summary section rendered by respective circuitry of the modular search object framework.

FIG. 15b illustrates an example expanded and displayed sponsored entity search result object associated with a thing. Specifically, this depiction of the expanded object associated with a thing includes multiple interactive sections rendered by respective circuitry of the modular search object framework.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### OVERVIEW

Provided herein are novel systems, methods, and circuitry related to the sponsorship and monetization of entity based content (such as entity search results and graphical user interfaces (GUIs)). Also, provide herein are novel systems, methods, and circuitry related to the sponsorship and monetization of modular search objects and frameworks for supporting entity based content, modular search objects, and user interactions with the aforementioned. For example, technologies described herein provide for sponsorship of content within a modular search object framework. The manner of sponsorship and monetization described herein provides for less intrusive advertising and a more manageable environment for online browsing in a mobile context.

In providing sponsorship and monetization of entity based content, the aforementioned technologies can link sponsored and monetized search terms with entities, so that entities can be sponsored and monetized without additional bidding and sponsorship. Once the framework generates such links, advertisers may continue to bid on search terms, and create new links or change initial links. Also, through the framework advertisers may bid on an entity that can encompass a set of associated search terms. For example, instead of bidding on a great number of search terms, an advertiser can bid on a few entities that include at least a majority of the search terms. With such functionality, the workload of the advertiser can be greatly reduced. Also, such functionality allows for missed associations and selections of keywords and for further associations and selections that may not be known yet. With these features, there can be a first bidding tool for advertisers to bid on keywords, a second bidding tool for advertisers to bid on links between keywords and entities, a third bidding tool for advertisers to bid on entities, and circuitry on the backend to resolve conflicts and/or establish links between databases of any combination of these tools, for example.

Also, in an example, the sponsorship of entities and/or search terms may be exclusive or may be increased to improve positioning of advertising or an entity. For example, exclusive sponsorship of an entity may include sponsorship of all search terms exclusively linked to the entity. For example, Organizing for Action (OFA) may exclusively sponsor entity objects (such as entity GUIs) for Barack Hussein Obama II the politician. Search terms that are exclusively linked to such entity objects may then be also exclusively sponsored by OFA. With respect to increasing sponsorship to improve emphasis of ads, an advertiser may pay more to have an ad further emphasized. With respect to increasing sponsorship to improve positioning of an entity, an advertiser may pay more to have a sponsored entity search result moved to a more perceivable position. For example, an advertiser can pay more to have a sponsored entity search result move up in search results.

With regard to audiences, when a user searches for a specific entity, such as executes a query with search term “Obama”, usually it is the intent of the user to retrieve information associated with the entity Barack Hussein Obama II the politician.

In the context of a specific business entity, when a user searches for a specific service or product, he or she is usually intending to discover corresponding service or product information, contact information, and information regarding related entities. For example, given a food and beverage business, such as a hypothetical coffee company named Green Can Coffee, a user searching online for Green Can Coffee may likely intend to discover a location of a Green Can Coffee storefront, a phone number for that location, and a review on the location and perhaps Green Can Coffee in general. Not only do users want the information, but also they want it delivered quickly and in a seamless manner. This is especially the case with users on mobile devices, since there is a likelihood that the user is on the go. To provide such information with or within conventional lists of search results can be difficult to parse for a user equipped with a small screen. This is especially the case when the user is in transit. In the mobile context, the user may want the nearest location to an entity, such as a location of a Green Can Coffee storefront. That user may also want directions to the storefront and reviews on the storefront. Also, a user may want to know hours the entity operates, links to coupons or offers the entity is currently providing, and links to download or interact with applications provided or associated with the entity.

Any of the predicted intent of a user can be captured by tracking user interactions with the mobile device and the accompanying applications. The predictions can be based on the tracked interactions and can then be used to provide content a user likely desires. Such functionality and predicted information can be maintained by the entity, an agent of the entity, or the service provider providing the modular search object framework.

To the benefit of the consumer and the advertiser, a content network provider or search engine provider can provide content and search results in a manner that is more digestible to a mobile device user through the framework. As mentioned, a long list of links to webpages may be cumbersome with a smaller display, whether those webpages are adapted for a mobile context or not. Although, the entity model of delivering search results can be combined with more conventional methods within non-mobile contexts, where screen sizes may be larger and user interface peripherals are more likely to be used. Also, advertisers can customize their own summary page or more through the framework in ways that can enhance user experience, which in turn may increase revenue for the advertiser and the service provider monetizing the content. Additionally or alternatively, search results and related GUIs may include algorithmically generated summary sub-GUIs providing a more cohesive experience for a user than a list of search results.

The modular search object framework can bridge a gap in the current state of the art. Human curated results are not scalable amongst a great reach of content. To resolve this issue, automation of content curation can be implemented through the framework. Also, through human curation, updating of content may not be consistent on a large scale. Through the framework, predictive circuitry can regularly and algorithmically generate results and associated GUIs. Additionally or alternatively, such functionality can be enhanced by entity owners providing updated information through data feeds or information management tools. The feeds for business entities may contain information such as office hours, business locations, phone numbers, recent promotions, coupons, application links to their applications at an online application store, and links of extended information such as ratings, reviews, check-in information, images, products sold, and the like. Further, such information can be provided to an advertiser's audience by context of a user in the audience. For example, such information, including entity related applications, may be delivered according to an interest profile of the user and/or a geographic location of the user.

Additionally, the provider of an online entity module served through the framework can charge the actual entity or at least a claimer of the online entity a fee for sponsorship of the online module associated with the entity. Hence, the online entity module becomes a sponsored entity module, and aspects of that entity module can be monetized and paid for by the sponsor to the provider. The aspects may include clickable links, monitored content, applications, such as widgets, and the like. Charges may be derived from impressions of the aforementioned, or user interactions with the aforementioned, such as clicks on links, content dwell times, and gestures on application controls.

The aforementioned functions and benefits of a modular search object framework can be immediate by linking search terms with entities. Especially is such links are automated. The automation can be based on search and search result logs and corresponding analytics data.

Also, monetization and sponsorship of content provided through the modular search object framework can be streamlined by linking search terms with entities. For example, advertisers can bid on entities and entity parts that encompass search terms most closely associated with the entities and entity parts, instead of bidding on a large plurality of search terms in an attempt to cover all or most search terms that relate to the entities and entity parts. With this functionality, an advertiser may provide ads to intended audiences more efficiently and effectively.

### DESCRIPTION OF THE DRAWINGS

Prior to the detailed description of the drawings, provided are explanations of terms used within the description of the drawings and the remainder of the disclosure.

An entity search result is a search result that is based on an entity (such as a particular person, place, or thing). An entity search result or other form of entity based content delivery, such as an entity graphical user interface (GUI), is distinguishable from non-entity content in that in a system, such as a system of a content provider, content for a particular entity is delivered through a single root object made up of one or more sub-objects. With a non-entity search result, the result is not necessarily associated with one root object for a particular entity; there may be many root search results for a particular entity. Also, in a non-entity based system, there may be multiple root graphical user interfaces (GUIs), such as multiple root webpages, for a single entity. In an entity based content system, there is one root object per entity. In one example of an entity based system, there may be only one webpage per entity. For example, for the thing Green Can Coffee, in such an entity based system, there is only one root object for the thing Green Can Coffee (such as one root webpage for Green Can Coffee the business). Whereas, in a non-entity based content system, there may be many root objects for the thing Green Can Coffee. For example with a non-entity content delivery system, there may be many different root webpages and websites for the thing Green Can coffee. With an entity based content delivery system, there is only one root object. Given that there is only one root object per entity in the framework, there may be many entity sub-objects under the entity root object. WIKIPEDIA may be considered an entity based system of content delivery. One aspect of the framework described herein attempts to remove ambiguity with entities, which may be experienced with WIKIPEDIA. In an example of the framework, entities that may cause ambiguity in the system may be denied entry into the system.

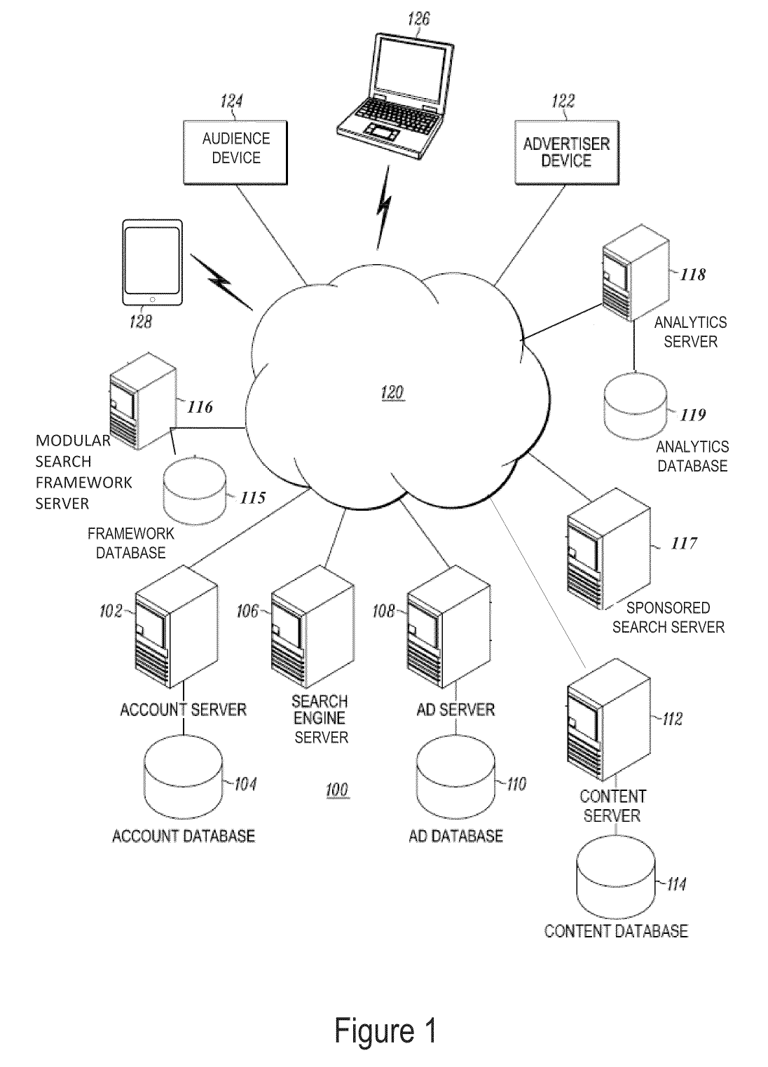

FIG. 1 illustrates a block diagram of an example information system that includes example devices of a network that can provide a modular search object framework; and through the framework can provide monetized and/or sponsored online information, such as monetized and/or sponsored entity search results and related GUIs. Online information or a graphical element containing such information is monetized when such information or element is utilized as a source of revenue. Online information or a graphical element containing such information is sponsored when such information or element is paid for or at least claimed by an advertiser such as an advertising organization, person, group of people, or any combination thereof.

The information system 100 in the example of FIG. 1 includes an account server 102, an account database 104, a search engine server 106, an ad server 108, an ad database 110, a content database 114, a content server 112, a modular search framework server 116 (which is communicatively coupled with a framework database 115), a sponsored search server 117 (which can also be communicatively coupled with a corresponding database), an analytics server 118, and an analytics database 119. The aforementioned servers and databases can be communicatively coupled over a network 120.

The information system 100 may be accessible over the network 120 by advertiser devices, such as an advertiser client device 122 and by audience devices, such as an audience client device 124. An audience device can be a client device that presents online content, such as entity and non-entity search results, search suggestions, content, and advertisements, to a user. Entity and non-entity search results can be monetized and/or sponsored. In various examples of such an online information system, users may search for and obtain content from sources over the network 120, such as obtaining content from the search engine server 106, the ad server 108, the ad database 110, the content server 112, the content database 114, the framework database 115, the modular search framework server 116, and the sponsored search server 117. Advertisers may provide advertisements for placement on electronic properties, such as webpages, and other communications sent over the network to audience devices, such as the audience client device 124. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. Also, examples include analytics data related to their ads and associated content and user interactions with the aforementioned. In an example, the analytics data may be in the form of one or more sketches, such as in the form of a sketch per audience segment, segment combination, or at least part of a campaign. The account information may include ad booking information. This booking information can be used as input for determining ad impression availability.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

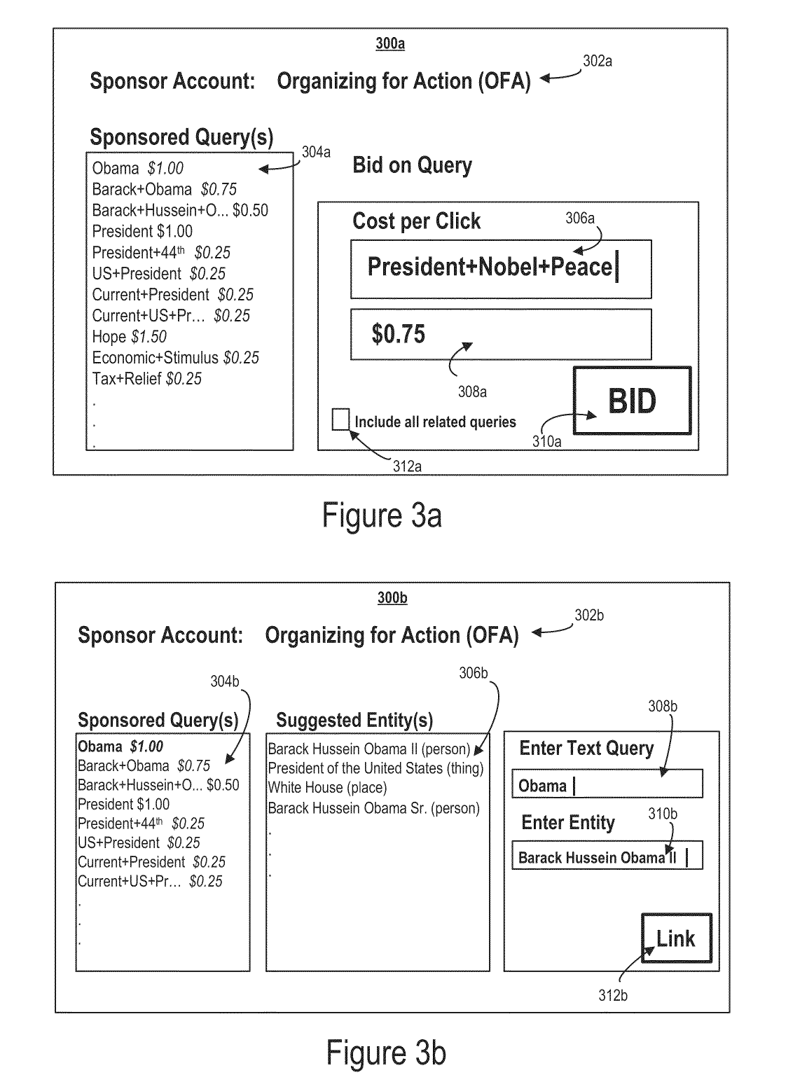

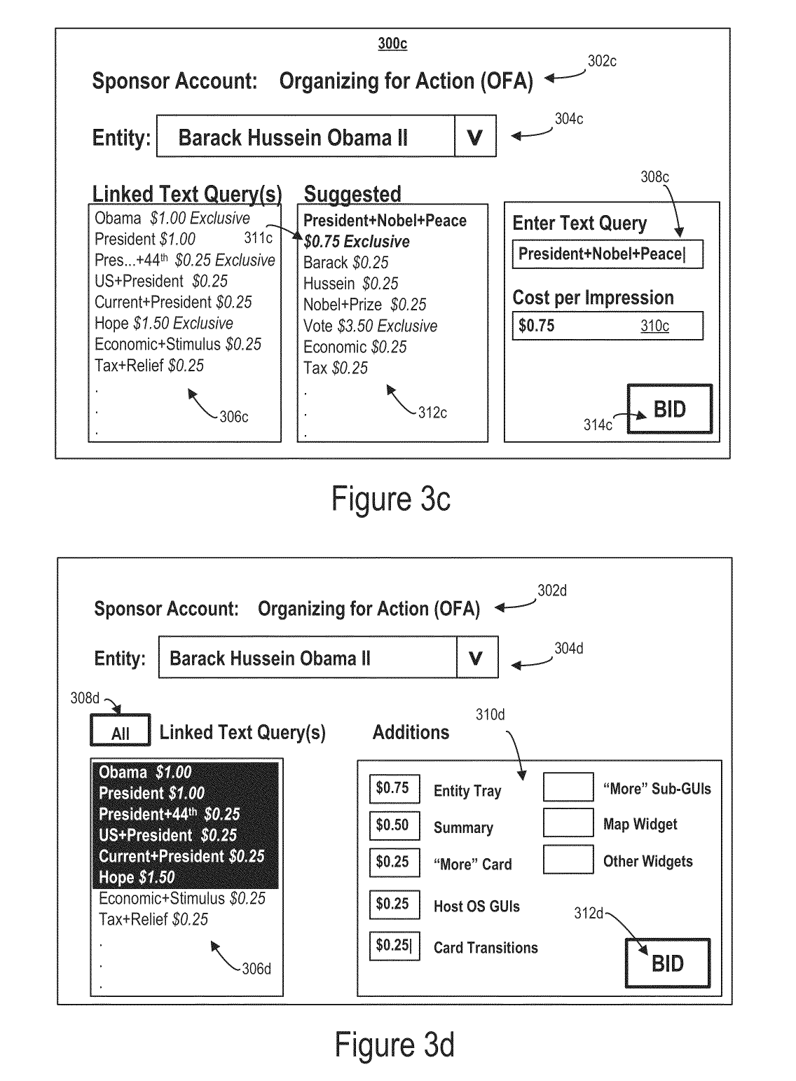

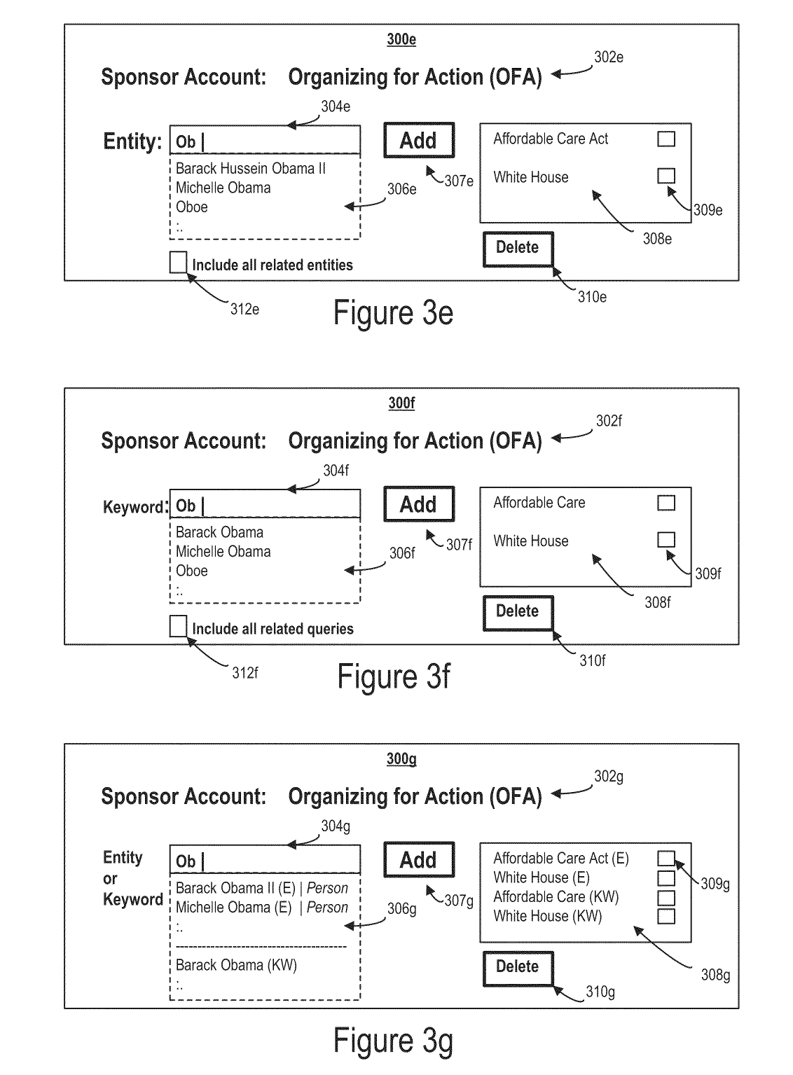

The account server 102 may provide an advertiser front end to simplify the process of accessing the account information of an advertiser (such as a client-side application). The advertiser front end may be a program, application, or software routine that forms a user interface. In a particular example, the advertiser front end is accessible as a website with electronic properties that an accessing advertiser may view on an advertiser device, such as the advertiser client device 122. The advertiser may view and edit account data and advertisement data, such as ad booking data, using the advertiser front end. After editing the advertising data, the account data may then be saved to the account database 104. Example advertiser front end GUIs are depicted in FIGS. 3a-3d.

Also, audience analytics, impressions delivered, impression availability, and segments may be viewed in real time using the advertiser front end. The advertiser front end may be a client-side application, such as a client-side application running on the advertiser client device. A script and/or applet (such as a script and/or applet) may be a part of this front end and may render access points for retrieval of the audience analytics, impressions delivered, impression availability, and segments. In an example, this front end may include a graphical display of fields for selecting an audience segment, segment combination, or at least part of a campaign. The front end, via the script and/or applet, can request the audience analytics, impressions delivered, and impression availability for the audience segment, segment combination, or at least part of a campaign. The information can then be displayed, such as displayed according to the script and/or applet.

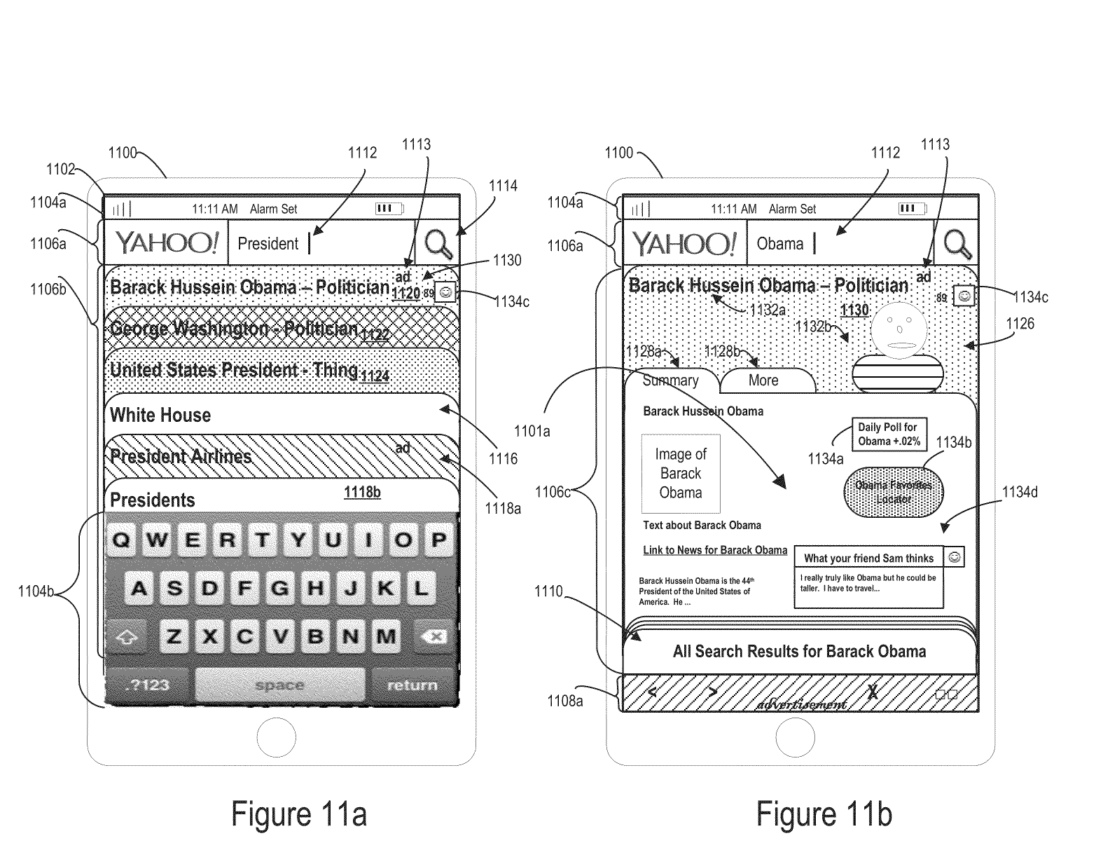

Referring back to FIG. 1, the search engine server 106, the modular search framework server 116, the sponsored search server 117, or any combination thereof may be one or more servers. Alternatively, the search engine server 106, the modular search framework server 116, the sponsored search server 117, or any combination thereof may be a computer program, instructions, or software code stored on a computer-readable storage medium that runs on one or more processors of one or more servers. The search engine server 106, the modular search framework server 116, the sponsored search server 117, or any combination thereof may be accessed by audience devices, such as the audience client device 124 operated by an audience member over the network 120. Access may be through graphical access points. For example, query entry box (such as the query entry box 1112 illustrated in FIGS. 11a-12a and 13a-15b) may be an access point for the user to submit a search query to the search engine server 106, the modular search framework server 116, the sponsored search server 117, or any combination thereof, from the audience client device 124. Search queries submitted or other user interactions with such servers can be logged in data logs, and such logs may be communicated to the analytics server 118 for processing. After processing, the analytics server 118 can output corresponding analytics data to be served to the search engine server 106, the modular search framework server 116, the sponsored search server 117, or any combination thereof for determining entity and non-entity non-sponsored search results, entity and non-entity sponsored search results, and other types of content and ad impressions. Analytics circuitry may be used to determine analytics data, and such circuitry may be embedded in any one of the servers and client devices illustrated in FIG. 1.

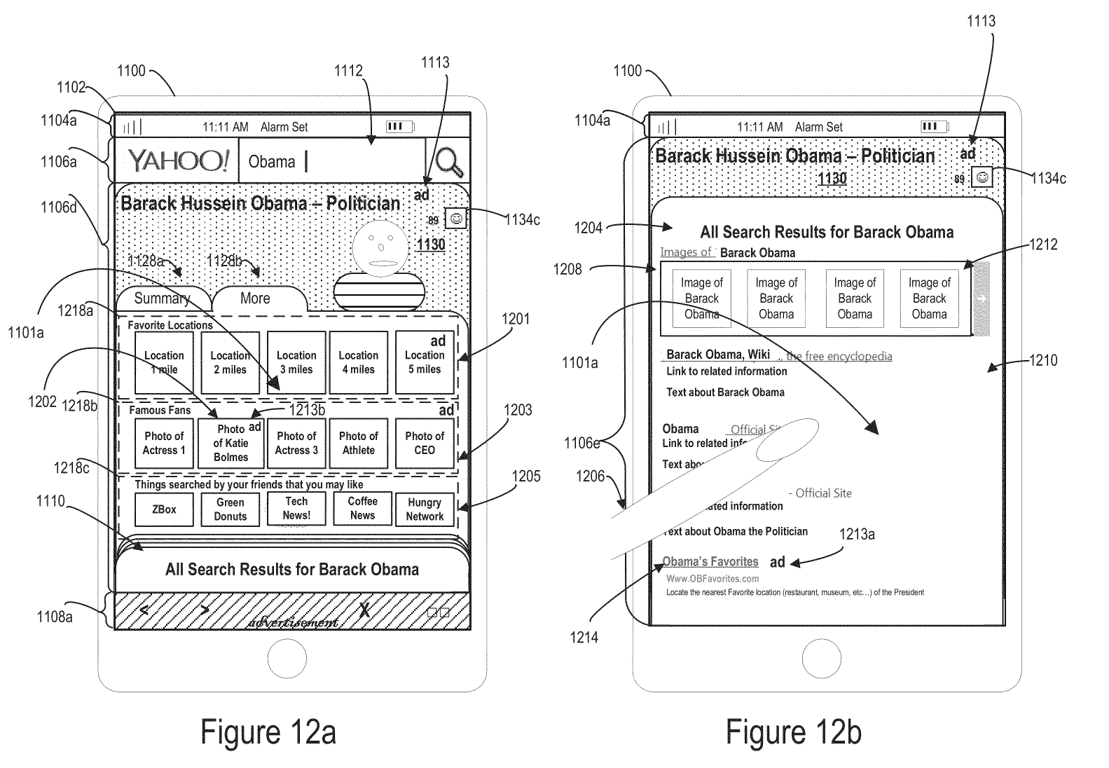

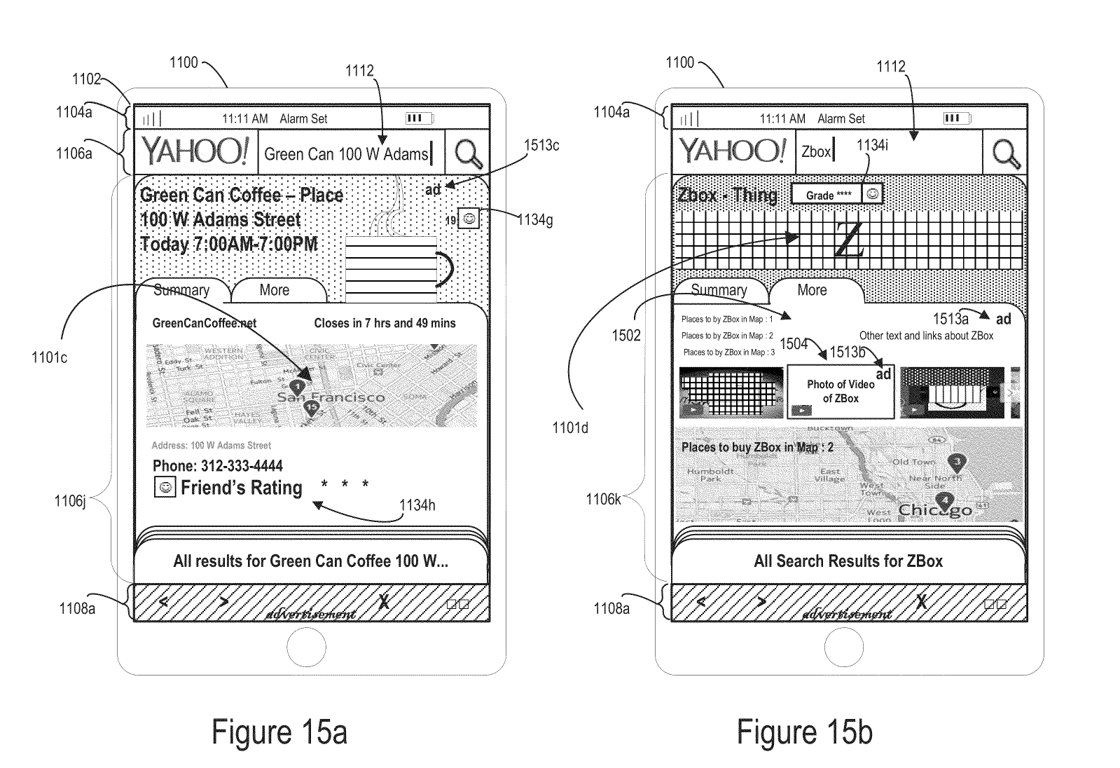

Besides a search query, the audience client device 124 can communicate interactions with a search result and/or a search suggestion, such as interactions with a sub-GUI associated with the search result appearing on the same page view as the search result. Such interactions can be communicated to any one of the servers illustrated in FIG. 1, for example. The search engine server 106, the modular search framework server 116, the sponsored search server 117, or any combination thereof can locate information matching the queries and the interactions using a suitable protocol or algorithm and returns the matching information to the audience client device 124, such as in the form of search suggestions, monetized and/or sponsored search results, entity search results, non-entity search results, associated GUIs, and any combination thereof. An example of non-entity search results can include a list of webpage search results. Webpage search results may include a link to a corresponding webpage and a short corresponding blurb and/or text scraped from the webpage. The search engine server 106, the modular search framework server 116, the sponsored search server 117, or any combination thereof may receive user interaction information, that can include search queries, from an audience device, and send corresponding information to the ad server 108 and/or the content server 112, and the ad server 108 and/or the content server 112 may serve corresponding ads and/or search results, but with more in-depth details or accompanying GUIs and sub-GUI for interacting with subject matter associated with ads, entity search results, non-entity search results, or any combination thereof. The information inputted and/or outputted by these devices may be logged in data logs and communicated to the analytics server 118 for processing, over the network 120. The analytics server 118 can provide analyzed feedback for affecting future serving of content. For example, the analytics server 118 can provide feedback for affecting serving of ads, search suggestions, entity search results, non-entity search results, respective GUIs (such as sponsored entity trays 1101a-1101c illustrated in FIGS. 11b-15a, respectively, and sub-GUIs (such as sponsored “more” GUI 1502 illustrated in FIG. 15b and sponsored miniature tray 1218b illustrated in FIG. 12a) included with and/or associated with the ads, search suggestions, entity search results, and non-entity search results, or any combination thereof.

The search engine server 106, the modular search framework server 116, the sponsored search server 117, or any combination thereof may be designed to help users and potential audience members find information located on the Internet or an intranet. In an example, these servers or any combination thereof may also provide to the audience client device 124 over the network 120 an electronic property, such as a webpage and/or entity tray, with content, including search results, ads, information matching the context of a user inquiry, links to other network destinations, or information and files of information of interest to a user operating the audience client device 124, as well as a stream or webpage of content items and advertisement items selected for display to the user. The aforementioned provided properties and information, solely or in any combination, may be monetized and/or sponsored. The aforementioned properties and information provided by these servers or any combination thereof may also be logged, and such logs may be communicated to the analytics server 118 for processing, over the network 120. Once processed into corresponding analytics data, the analytics server 118 can provide analyzed feedback for affecting future serving of content. For example, the analytics server 118 can provide feedback for affecting serving of ads, search suggestions, entity search results, non-entity search results, respective GUIs and sub-GUIs included with and/or associated with the ads, search suggestions, entity search results, and non-entity search results, or any combination thereof.

The search engine server 106, the modular search framework server 116, the sponsored search server 117, or any combination thereof may enable a device, such as the advertiser client device 122, the audience client device 124, or another type of client device, to search for files of interest using a search query, such as files associated with sponsored entity trays. Typically, these servers or any combination thereof may be accessed by a client device over the network 120. These servers or any combination thereof may include a crawler component, an indexer component, an index storage component, a search component, a ranking component, a cache, a user or group profile storage component, an entity storage component, a logon component, a user or group profile builder, an entity builder, and application program interfaces (APIs), such as APIs corresponding with the modular search framework. These servers or any combination thereof may be deployed in a distributed manner, such as via a set of distributed servers, for example. Components may be duplicated within a network, such as for redundancy or better access.

The ad server 108 operates to serve advertisements to audience devices, such as the audience client device 124. An advertisement may include text data, graphic data, image data, video data, or audio data. Advertisements may also include data defining advertisement information that may be of interest to a user of an audience device. The advertisements may also include respective audience targeting information or ad campaign information, such as information on audience segments and segment combinations. An advertisement may further include data defining links to other online properties reachable through the network 120, such as to sponsored and non-sponsored entity trays. Also, entity GUIs and other types of properties (such as sponsored entity trays and sub-GUIs related to those trays) may be or include an advertisement. The aforementioned audience targeting information and the other data associated with an ad may be logged in data logs and such logs may be communicated to the analytics server 118 for processing. Once processed into corresponding analytics data, the analytics server 118 can provide analyzed feedback for affecting future serving of content, such as monetized and/or sponsored content. For example, the analytics server 118 can provide feedback for affecting serving of ads, search suggestions, entity search results, non-entity search results, respective GUIs and sub-GUIs included with and/or associated with the ads, search suggestions, entity search results, and non-entity search results, and any combination thereof.

For online service providers, advertisements may be displayed on electronic properties resulting from a user-defined search based, at least in part, upon search terms. These search terms may be organized per entity by the framework. Advertising may be beneficial to users, advertisers or web portals if displayed advertisements are relevant to audience segments, segment combinations, or at least parts of campaigns. Thus, a variety of techniques have been developed to determine corresponding audience segments or to subsequently target relevant advertising to audience members of such segments. For example user interests, user intentions, and targeting data related to segments or campaigns may be may be logged in data logs and such logs may be communicated to the analytics server 118 for processing. Once processed into corresponding analytics data, the analytics server 118 can provide analyzed feedback for affecting future serving of content. Besides organizing search terms per entity, such search terms can further be organized amongst entities by the feedback described in this paragraph and other paragraphs described herein.

One approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. The aforementioned targeting data, such as demographic data and psychographic data, may be logged in data logs and such logs may be communicated to the analytics server 118 for processing. Once processed into corresponding analytics data, the analytics server 118 can provide analyzed feedback for affecting future serving of content.

Another approach includes profile-type ad targeting. In this approach, user or group profiles specific to a respective user or group may be generated to model user behavior, for example, by tracking a user's path through a website or network of sites, and compiling a profile based, at least in part, on entity GUIs (such as entity trays), webpages, and advertisements ultimately delivered. A correlation may be identified, such as for user purchases, for example. An identified correlation may be used to target potential purchasers by targeting content or advertisements to particular users. The aforementioned profile-type targeting data may be logged in data logs and such logs may be communicated to the analytics server 118 for processing. Once processed into corresponding analytics data, the analytics server 118 can provide analyzed feedback for affecting future serving of content.

Yet another approach includes targeting based on content of an electronic property requested by a user, such as content of an entity GUI (such as an entity tray) or webpage requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching search terms, and/or phrases within the advertisement and the electronic property. The aforementioned targeting data may be logged in data logs and such logs may be communicated to the analytics server 118 for processing. Once processed into corresponding analytics data, the analytics server 118 can provide analyzed feedback for affecting future serving of content.

The ad server 108 includes logic and data operative to format the advertisement data for communication to a user device, such as an audience member device. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs and such logs may be communicated to the analytics server 118 for processing. Once processed into corresponding analytics data, the analytics server 118 can provide analyzed feedback for affecting future serving of content.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look and feel for advertising items in the stream. Such a stream may be included in or combined with an entity GUI (such as an entity tray). Also, a related entity GUI can include a similar appearance, size, shape, text formatting, graphics formatting and included information to provide a consistent look and feel between the entity GUI and the stream. Also, sponsored entity GUIs and sub-GUIs, opposed to non-sponsored entity GUIs and sub-GUIs, can include a similar appearance, size, shape, text formatting, graphics formatting, or combination thereof to provide a consistent look and feel between each other and/or a sponsored stream. Additionally, data related to the aforementioned formatting may be logged in data logs and such logs may be communicated to the analytics server 118 for processing. Once processed into corresponding analytics data, the analytics server 118 can provide analyzed feedback for affecting future serving of content.

Further, the ad server 108 is in data communication with the network 120. The ad server 108 communicates ad data and other information to devices over the network 120. This information may include advertisement data communicated to an audience device. This information may also include advertisement data and other information communicated with an advertiser device, such as the advertiser client device 122. An advertiser operating an advertiser device may access the ad server 108 over the network to access information, including advertisement data. This access may include developing advertisement creatives, editing advertisement data, deleting advertisement data, setting and adjusting bid amounts and other activities. This access may also include a portal for interacting with, viewing analytics associated with, and editing parts of entity GUIs (such as entity trays) the advertiser at least partially controls or owns. The ad server 108 then provides the ad items and/or entity GUIs to other network devices, such as the modular search framework server 116, the analytics server 118, and/or the account server 102, for classification (such as associating the ad items and/or entity GUIs with audience segments, segment combinations, or at least parts of campaigns). This information can be used to provide feedback for affecting serving of ads, search suggestions, entity search results, non-entity search results, respective GUIs and sub-GUIs included with and/or associated with the ads, search suggestions, entity search results, and non-entity search results, or any combination thereof.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device.

The ad server 108, the content server 112, or any other server described herein may be one or more servers. Alternatively, the ad server 108, the content server 112, or any other server described herein may be a computer program, instructions, and/or software code stored on a computer-readable storage medium that runs on one or more processors of one or more servers. The ad server 108 may access information about ad items either from the ad database 110 or from another location accessible over the network 120. The ad server 108 communicates data defining ad items and other information to devices over the network 120. The content server 112 may access information about content items either from the content database 114 or from another location accessible over the network 120. The content server 112 communicates data defining content items and other information to devices over the network 120. Content items and the ad items may include any form of content included in ads, search suggestions, entity search results, non-entity search results, respective GUIs and sub-GUIs included with and/or associated with the ads, search suggestions, entity search results, and non-entity search results, or any combination thereof.

The information about content items may also include content data and other information communicated by a content provider operating a content provider device, such as respective audience segment information and possible links to entity search results, trays, and other types of entity GUIs. A content provider operating a content provider device may access the content server 112 over the network 120 to access information, including the respective segment information, entity search result information, and entity GUI information. This access may be for developing content items, editing content items, deleting content items, setting and adjusting bid amounts and other activities, such as associating content items with audience segments, segment combinations, or at least parts of campaigns. A content provider operating a content provider device may also access the analytics server 118 over the network 120 to access analytics data. Such analytics may help focus developing content items, editing content items, deleting content items, setting and adjusting bid amounts, and activities related to distribution of the content, such as distribution of content via monetized and sponsored entity search results and GUIs (such as monetized and sponsored entity trays).

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120, such as devices administering monetized and sponsored entity search results and GUIs.

The content provider front end may be a client-side application, such as a client-side application running on the advertiser client device or the audience client device, respectively. A script and/or applet, such as the script and/or applet, may be a part of this front end and may render access points for retrieval of impression availability data (such as the impression availability data), and the script and/or applet may manage the retrieval of the impression availability data. In an example, this front end may include a graphical display of fields for selecting audience segments, segment combinations, or at least parts of campaigns. Then this front end, via the script and/or applet, can request the impression availability for the audience segments, segment combinations, or at least parts of campaigns. The analytics can then be displayed, such as displayed according to the script and/or applet. Such analytics may also be used to provide feedback for affecting serving of ads, search suggestions, entity search results, non-entity search results, respective GUIs and sub-GUIs included with and/or associated with the ads, search suggestions, entity search results, and non-entity search results, and any combination thereof.

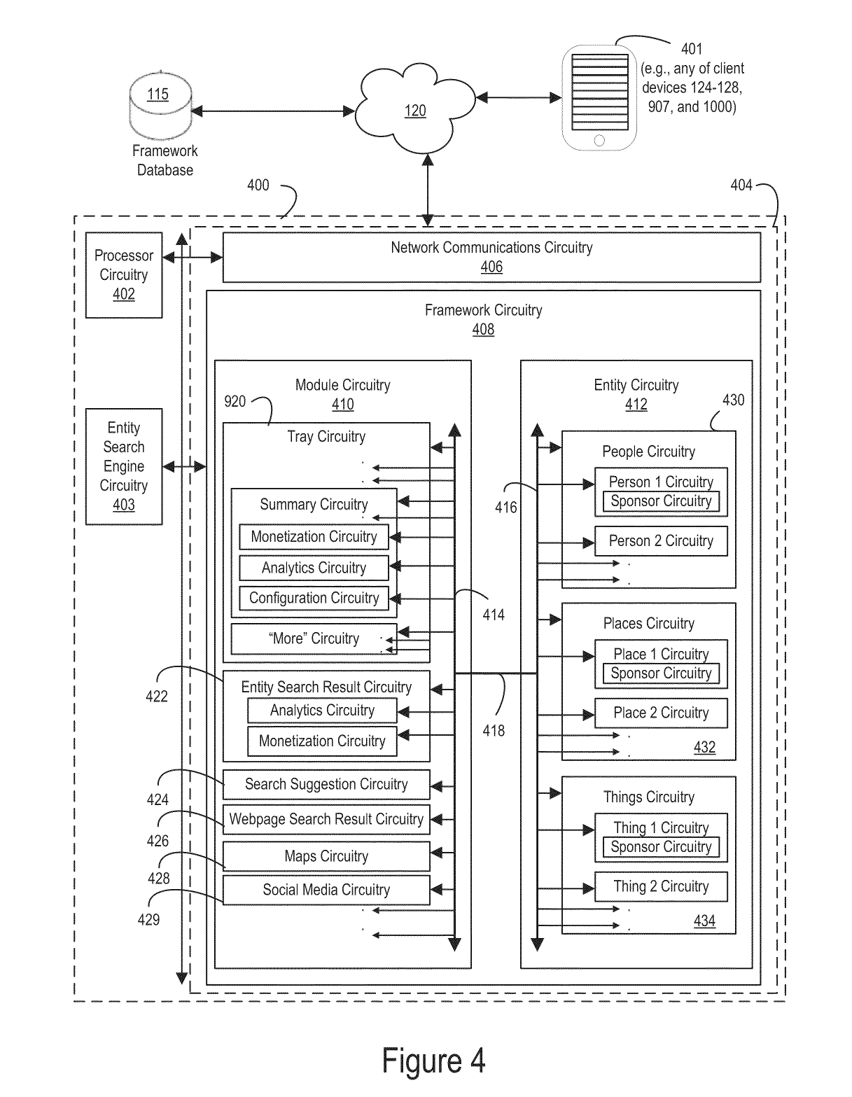

The content server 112 includes logic and data operative to format content data for communication to the audience device. The content server 112 can provide content items or links to such items to the analytics server 118 and/or the modular search framework server 116 for analysis or associations with entities, respectively. For example, content items and links may be matched to data and circuitry, such as entity data and circuitry and even module circuitry and data (e.g., module circuitry 410 in FIG. 4). The matching may be complex and may be based on historical information related to the audience segments and impression availability.

The content data may be formatted to a content item that may be included in a stream of content items and advertisement items provided to an audience device. The formatted content items can be specified by appearance, size, shape, text formatting, graphics formatting and included information, which may be standardized to provide a consistent look and feel for content items in the stream. Such a stream may be included in or combined with an entity GUI (such as an entity tray). Also, a related entity GUI can include a similar appearance, size, shape, text formatting, graphics formatting and included information to provide a consistent look and feel between the entity GUI and the stream. Additionally, aforementioned formatting data may be logged in data logs and such logs may be communicated to the analytics server 118 for processing. Once processed into corresponding analytics data, the analytics server 118 can provide analyzed feedback for affecting future serving of content.

In an example, the content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs and such logs may be communicated to the analytics server 118 for processing. Once processed into corresponding analytics data, the analytics server 118 can provide analyzed feedback for affecting future serving of content.

The aforementioned servers and databases may be implemented through a computing device. A computing device may be capable of sending or receiving signals, such as over a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views, entity search results and GUIs (such as entity trays), or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). Such sites may be integrated with the framework via the modular search framework server 116. An online server system may also host a variety of other sites, including, but not limited to business sites, educational sites, dictionary sites, encyclopedia sites, wikis, financial sites, government sites, etc. These sites, as well, may be integrated with the framework via the modular search framework server 116.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, may employ differing architectures or may be compliant or compatible with differing protocols, and may interoperate within a larger network, such as the network 120.

The advertiser client device 122 includes a data processing device that may access the information system 100 over the network 120. The advertiser client device 122 is operative to interact over the network 120 with any of the servers or databases described herein. The advertiser client device 122 may implement a client-side application for viewing electronic properties and submitting user requests. The advertiser client device 122 may communicate data to the information system 100, including data defining electronic properties and other information. The advertiser client device 122 may receive communications from the information system 100, including data defining electronic properties and advertising creatives. The aforementioned interactions and information may be logged in data logs and such logs may be communicated to the analytics server 118 for processing. Once processed into corresponding analytics data, the analytics server 118 can provide analyzed feedback for affecting future serving of content.

In an example, content providers may access the information system 100 with content provider devices that are generally analogous to the advertiser devices in structure and function. The content provider devices provide access to content data in the content database 114, for example.

The audience client device 124 includes a data processing device that may access the information system 100 over the network 120. The audience client device 124 is operative to interact over the network 120 with the search engine server 106, the ad server 108, the content server 112, and the analytics server 118, and the modular search framework server 116. The audience client device 124 may implement a client-side application for viewing electronic content and submitting user requests. A user operating the audience client device 124 may enter a search request and communicate the search request to the information system 100. The search request is processed by the search engine and search results are returned to the audience client device 124. The aforementioned interactions and information may be logged in data logs and such logs may be communicated to the analytics server 118 for processing. Once processed into corresponding analytics data, the analytics server 118 can provide analyzed feedback for affecting future serving of content.

In other examples, a user of the audience client device 124 may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device 124. The aforementioned interactions and information may be logged in data logs and such logs may be communicated to the analytics server 118 for processing. Once processed into corresponding analytics data, the analytics server 118 can provide analyzed feedback for affecting future serving of content.

The advertiser client device 122 and the audience client device 124 operate as a client device when accessing information on the information system 100. A client device, such as the advertiser client device 122 and the audience client device 124 may include a computing device capable of sending or receiving signals, such as via a wired or a wireless network. In the example of FIG. 1, both laptop computer 126 and smartphone 128, which can be client devices, may be operated as either an advertiser device or an audience device.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example. A client device, such as the advertiser client device 122 and the audience client device 124, may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network. At least some of the features, capabilities, and interactions with the aforementioned may be logged in data logs and such logs may be communicated to the analytics server 118 for processing. Once processed into corresponding analytics data, the analytics server 118 can provide analyzed feedback for affecting future serving of content.

Also, the disclosed methods and systems may be implemented at least partially in a cloud-computing environment, at least partially in a server, at least partially in a client device, or in any combination thereof.

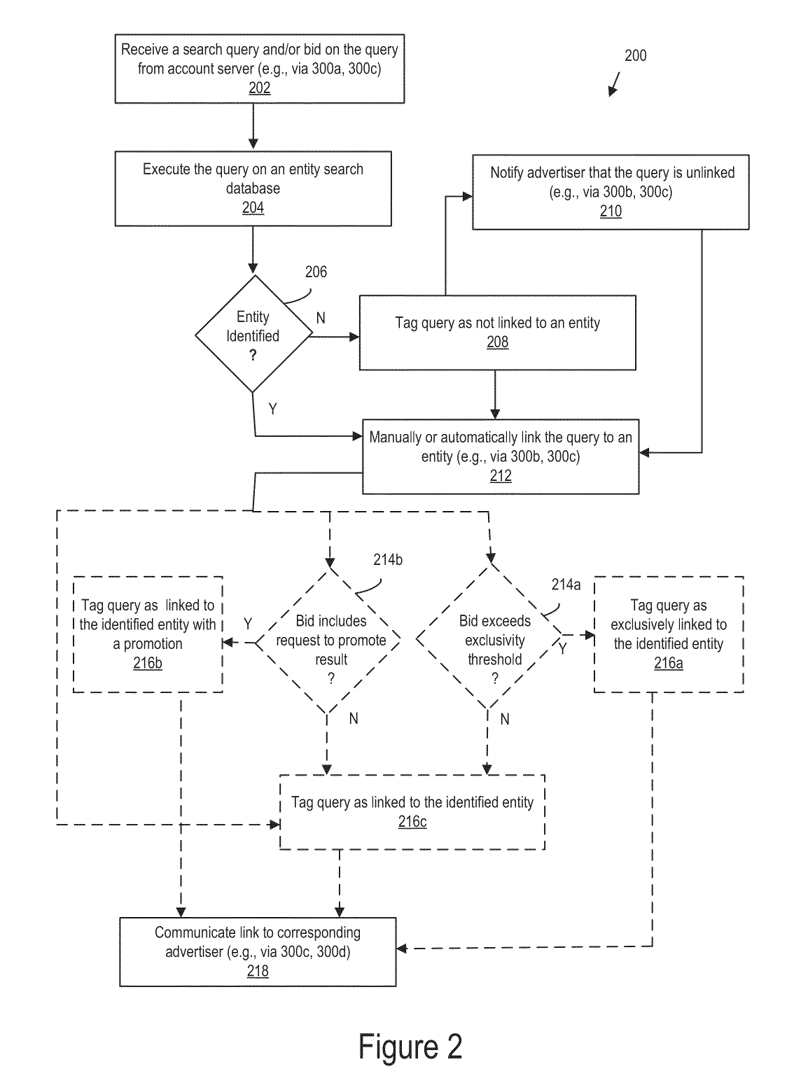

FIG. 2 illustrates example operations 200 of example circuitry of an example system that can provide aspects of the module search object framework. In an example, the operations can be performed by circuitry of a server, such as the modular search framework server 116 illustrated in FIG. 1. The operations 200 can include receiving a search query (such as a query including a word or a word combination including multiple words) and/or a bid on the search query from an advertiser front end and/or an account server (such as account server 102), at 202. The advertiser front end may include GUIs, such as GUIs 300a and 300c illustrated in FIGS. 3a and 3c, respectively, which can provide an interface for a user to input a search query and/or a bid on the search query. The receiving of the search query at 202 can occur at network communications circuitry (such as the network communications circuitry 406 illustrated in FIG. 4). Also, the communicated query received at 202 can occur over a network, such as the network 120 in FIG. 1.

The bid may include accepting a cost per an impression of and/or a click on an ad of the advertiser resulting from a user execution of the search query. An ad in such a context may include or be part of an entity search result, a non-entity search result, a part of content resulting from navigation from the entity search result or the non-entity search result, or any combination thereof, for example.

The operations 200 can also include executing the search query on an entity search database (such as an entity search database included in the framework database 115), at 204. The execution of the search can include identifying one or more word entries of a plurality of word and word combination entries stored in the entity search database, which match the search query. The entity search database can include a word data structure, such as a dedicated database table, containing the plurality of word and word combination entries. The entity search database can also include an entity data structure, such as a dedicated database table, containing a plurality of entity object entries.

The plurality of word and word combination entries link to the plurality of entity object entries according to manually generated links and/or automatically generated links. An automatically generated link can be generated according to correlations determined from analytics data, such as data outputted by the analytics server 118 in FIG. 1. A manual link can occur through an advertiser front end and/or account server. The advertiser front end may include GUIs, such as GUIs 300b and 300c, which can provide an interface for a user to link search queries to entities. As shown in these example GUIs, manual generation of the manually generated links may include providing an opportunity for the advertiser to bid on the linking of the one or more entity entries to the identified one or more word entries.

In an example, the execution at 204 can be performed by dedicated entity search engine circuitry such as entity search engine circuitry 403 in FIG. 4. The execution at 204 can also occur by all-encompassing search engine circuitry (such as by circuitry included in the framework circuitry 408 of FIG. 4 and/or circuitry included in the search engine server 106). The entity search database can be communicatively coupled to such circuitry and can include, at least part of, or be communicatively coupled with the ad database 110, the content database 114, the account database 104, the analytics database 119, or any combination thereof. The search engine circuitry can also be communicatively coupled to the network communications circuitry.

The operations 200 can also include identifying one or more word entries of a plurality of word and word combination entries stored in the entity search database that match the search query, at 206. This identification can include identifying an entity indicator in the search query, according to the execution of the search query on the entity search database. This identification at 206 can be done by the search engine circuitry, and can be part of the execution of the query on the entity search database. In such an example, upon identification of the entity indicator, the search engine circuitry can identify the entity search result according to the entity indicator. The match in the identification may occur due to the search query and a word or a word combination of the plurality of word and word combination entries having a same word or words. The match may also occur due to the search query and a word or a word combination of the plurality of word and word combination entries having a same word or words, irrespective of order of the words. The match may also occur due to the search query and a word or word combination of the plurality of word and word combination entries having a substantially similar word or words. The match may also occur due to a likeness score between the search query and a word or word combination of the plurality of word and word combination entries that exceed a likeness threshold. Upon any of these matches, an automated normalization process may occur to reduce word and word combination entries in the database. The normalization process may also reduce the amount of links between entities and search terms.

The operations 200 can also include identifying an additional query part besides the entity indicator in the search query (not depicted). Such an additional part may be linked to a sponsor of an entity and monetized. For example, such additional linking and monetization may occur through a GUI such as GUI 300d in FIG. 3d. The additional query part can include a question, an added detail, or context (such as date, time, and/or location of user performing the query). The identification of the additional query part can be according to the execution of the search query on the entity search database. This identification of the additional part can be done by the search engine circuitry, and can be part of the execution of the query on the entity search database. Upon identifying the additional query part, the operations 200 can also include executing the additional query part on the entity search database, a non-entity search database, or both, with respect to the entity search result. The non-entity search can be communicatively coupled to the search engine circuitry and can include at least part of the ad database, the content database, the account database, the analytics database, a database closely coupled to the modular search framework server 116, or any combination thereof.

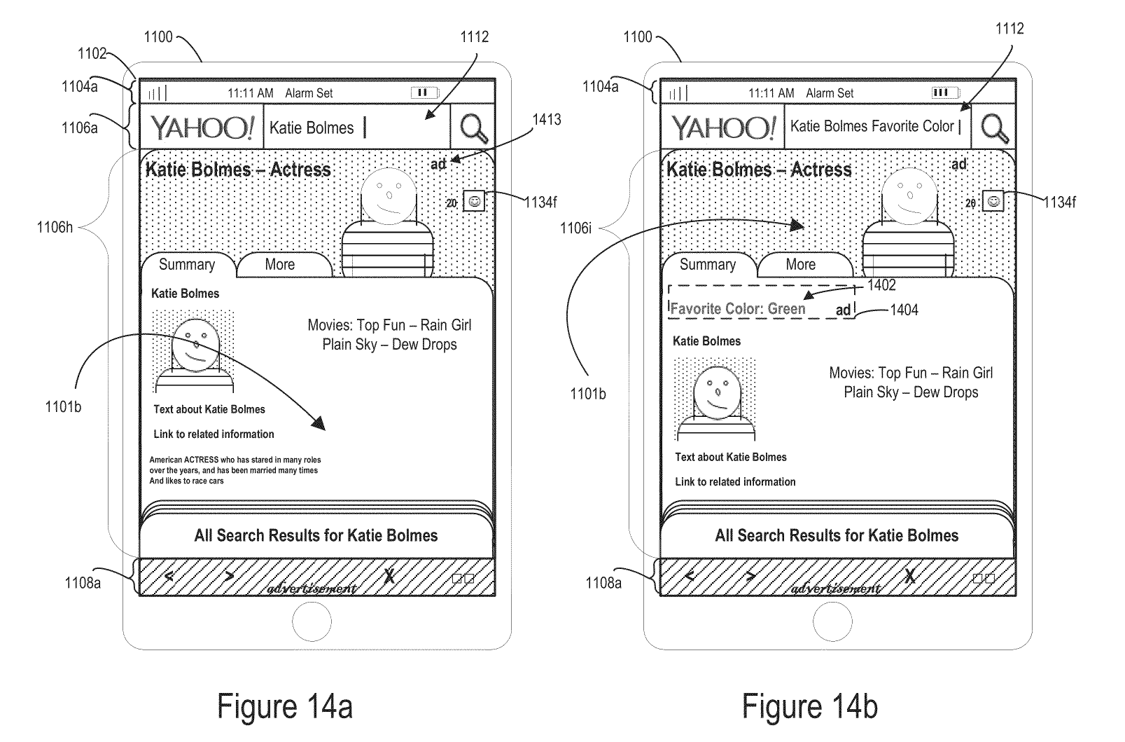

In an example when an additional query part is identified, the search engine circuitry can also be configured to interpret the search query as a question. When the query is interpreted as a question, the one or more additional search results can be provided as one or more answers to the question. For example, in FIG. 14b, the query input at the query box 1112 is “Katie Bolmes Favorite Color”. This can be interpreted into a question, such as “What is Katie Bolmes' favorite color?” As depicted in FIG. 14b, an answer to the question has been presented along with the presentation of the entity search result. The search engine circuitry may include or be communicatively coupled with analytic circuitry such as analytic circuitry of the analytics server 118, circuitry of the analytics database 119, circuitry of the modular search framework server 116 (such as analytic circuitry of the framework circuitry 408), circuitry of the framework database, client-side analytic circuitry (such as circuitry of the scripts and/or applets 1028), or any combination thereof. In other words, the search engine circuitry can be further configured to determine whether the one or more additional search results exist in the entity search result, and then may act accordingly. The framework can also emphasize the presentation of the one or more additional search results in the entity search result.

The emphasizing of the one or more additional search results in the entity search result can occur by adding a visual representation of the one or more additional search results in a predetermined position in a first graphical user interface (GUI). The predetermined position can be a variable position relative to other viewable information in the first GUI. Alternatively, the predetermined position can be fixed. As illustrated in FIG. 14b, the predetermined position 1404 can be above all entity-specific text of the first GUI besides a displayed title of the first GUI. Alternatively or additionally, the emphasizing of the one or more additional search results in the entity search result can be by including a visual representation of the one or more additional search results in a most forefront part of a first GUI. The most forefront part can be provided by making the most forefront part appear closer to the user viewing the first GUI than other parts. Also, the most forefront part can overlap at least one other part of the first GUI in addition to overlapping a background part, and may not be overlapped by any part of the first GUI. The most forefront part can also be sharper than at least a majority of other parts of the first GUI. Furthermore, the emphasizing of the one or more additional search results in the entity search result can be made by a visual representation of the one or more additional search results contrasting with background elements of a first GUI greater than contrasting of at least a majority of other visual objects of the first GUI with the background elements. In such an example, the first GUI can be an initial GUI to appear after a user selects the entity search result on the client device. The emphasizing of the one or more additional search results in the entity search result can also be made by enlarging a visual representation of the one or more additional search results relative to all other visual objects of a first GUI. Also, the emphasizing of the one or more additional search results in the entity search result can be made by reducing sizes of at least a majority of visual objects in a first GUI. The at least a majority of visual objects may exclude a visual representation of the one or more additional search results and a background object of the first GUI. Also, the emphasizing of the one or more additional search results in the entity search result can be made by audio outputting of the one or more additional search results. In an example, the audio outputting can occur while a first GUI to appear after the user selects the entity search result on the client device is outputted.

Also, initial or additional sponsored suggestions and search results may be positioned higher in a list of search results. For example, an entity search result may be positioned at the top of a list of mixed results. Additionally or alternatively, for example, an advertiser may pay to improve the position of an entity search result over other results in general and/or other entity search results. Improving the position may be moving the result higher than it would appear in a results list without the additional fee or moving the result to the top of the list. Advertisers may even bid on positioning for the top spot and/or lower ranking positions.

Referring back to FIG. 2, the operations 200 can also include tagging the search query as not being linked to an entity, at 208. For example, at 206, the link between the one or more words of the search query and an entity may not have been identified. In an example and as illustrated in FIG. 2, linking can occur manually by an advertiser.

For example, at 210, the operations 200 can include notifying an advertiser that the query is unlinked. For example, the GUIs 300b and 300c can notify an advertiser that a word or word combination is unlinked to an entity. Subsequent to notification or without notification, the operations 200 may include manual or automatic linking of the query to an entity, at 212. As illustrated, such linking can be done manually through a GUI, such as GUI 300b or GUI 300c.

Additionally or alternatively, in an example, the operations 200 can also include determining whether the bid exceeds an exclusivity threshold, at 214a. If the corresponding bid does not exceed the exclusivity threshold, the entity search engine device may be configured to tag the search query as not being exclusively linked. At 216a, the query (including the word or word combination) can be tagged as exclusively linked to the identified entity (identified at 206). Besides exclusivity, an advertiser can bid on improving the positioning of an ad or sponsored result. Alternatively or additionally, the operations 200 can also include determining whether the bid includes a request to promote a result, at 214b. If the bid includes such a request, then the entity search engine device may be configured to tag the search query as linked to the identified entity and to promote associated search results. The promotion may be for non-entity and/or entity search results. Promotion may include the emphasizing of a search result by increasing the probability that it is perceived. For example, moving the result up on a result list from where it would be without the promotion (such as moving a result to the top of a search list in consideration for an additional payment).

At 216c, if a link is identified between the search query and an entity the query is tagged as linked. Such a link may be communicated to a corresponding advertiser at 218, such as one that is associated with the entity or is the owner of the entity. In an example, the entity search engine circuitry can be configured to communicate to the advertiser device one or more entity object identifications associated with one or more entity entries of the plurality of entity object entries, wherein the one or more entity entries link to the identified one or more word entries. In these example operations, this tagging of the link may always occurs. In examples of these operations, the exclusivity and/or promotion features and tagging for such features may be added to the operations, as depicted in FIG. 2.

FIG. 3a illustrates an example graphical user interface (GUI) 300a configured to provide an interface for bidding on search terms. As depicted in FIG. 3a, a search term can include one or more words. A server, such as the account server 102, can provide information over a network to an advertiser client device that interprets the information to render the GUI 300a in FIGS. 3a. The GUI 300a can be rendered on a client side application, such as a web browser. The server that provides such information can include or be communicatively coupled with a first GUI system stored in a non-transitory device executable by processor circuitry.

The first GUI system can include first GUI circuitry configured to output an advertiser name of an advertiser, such as the sponsor name 302a. The first GUI system can also include second GUI circuitry configured to output one or more search terms sponsored by the advertiser, such as the list of words and word combinations 304a.

The first GUI system can also include third GUI circuitry configured to output a first input field configured to receive a search term, such as field 306a. In an example, input fields may include a menu (such as a drop-down list) that includes search term suggestions. For example, the field 304e includes a drop-down list 306e in FIG. 3e. The third GUI circuitry can also be configured to output a second input field configured to receive a bid amount for the search term, such as field 308a. The first GUI system can also include fourth GUI circuitry configured to output a field, such as field 310a, configured to receive a request to execute the inputted bid. This field that can receive a request to execute the bid can also be configured to communicate the search term and the bid amount to the system. The system can then determine whether to accept the bid. As illustrated, the field 310a is a clickable button. Any of the aforementioned input fields and any other input field described herein can receive a user input through a voice command input, a keyboard input, a keypad input, a gesture input, or any combination thereof. Also, in bidding on a search term, an advertiser may also bid on all related search terms. The search terms may be related through database links. As depicted in 3a, an advertiser may select to bid on all search terms related to the search term entered in field 306a, by selecting checkbox 312a.

FIG. 3b illustrates an example GUI configured to link a search term to an entity search result object. As depicted in FIG. 3b, a search term can include one or more words. A server, such as the account server 102, can provide information over a network to an advertiser client device that interprets the information to render the GUI 300b in FIG. 3b. The GUI 300b can be rendered on a client side application, such as a web browser. The server that provides such information can include or be communicatively coupled with a second GUI system stored in a non-transitory device executable by processor circuitry. The second GUI system can include first GUI circuitry configured to output an advertiser name of an advertiser, such as the sponsor name 302b. The second GUI system can also include second GUI circuitry configured to output one or more search terms sponsored by the advertiser, such as the list of words and word combinations 304b. The second GUI system can also include third GUI circuitry configured to output one or more suggested entities associated with the one or more sponsored search terms, such as the list of entity objects 306b.

The second GUI system can also include fourth GUI circuitry configured to output a first input field configured to receive a search term of the one or more sponsored search terms, such as field 308b. The first input field can be configured to receive the search term through a voice command input, a keyboard input, or a keypad input. The first input view can also be configured to receive the search term through a gesture selection input of the search from the one or more outputted search terms in the list of words and word combinations (such as the list 304b). The gesture selection input can be a click on a search term in the list of words and word combinations.

The fourth GUI circuitry can also be configured to output a second input field configured to receive an entity name of an entity associated with an entity object, such as field 310b. The fourth GUI circuitry can also be configured to output a third input field configured to receive a link request to link the search term and the entity, such as field 312b. The third input field (e.g., field 312b) can also be configured to send the request to link the search term and the entity, to the second GUI system over the network.

In another example, the fourth GUI circuitry can also be configured to output a fourth input field (not depicted) that can be configured to receive an exclusivity request for an exclusive link to the search term from the entity object. The fourth input field can also be configured to send the exclusivity request to the second GUI system over the network.

FIG. 3c illustrates an example GUI configured to provide an interface for bidding on a link between a search term and an entity search result object. As depicted in FIG. 3c, a search term can include one or more words. A server, such as the account server 102, can provide information over a network to an advertiser client device that interprets the information to render the GUI 300c. The GUI 300c can be rendered on a client side application, such as a web browser. The server that provides such information can include or be communicatively coupled with a third GUI system stored in a non-transitory device executable by processor circuitry. The third GUI system can include first GUI circuitry configured to output entity object information, the entity object information including an entity title (such as entity title 304c) and an entity sponsor of an entity object (such as entity sponsor 302c). The entity title can be a first entity title and the first GUI circuitry can be further configured to output a second entity title of a second entity object associated with the outputted entity sponsor. The first and the second entity titles can be in an outputted list, such as a dropdown list. The list of entity titles can include many more than two titles.

The third GUI system can also include a second GUI circuitry configured to output at least one word or word combination linked to the entity object, such as the list of linked search terms 306c. The second GUI circuitry can also be further configured to output at least one word or word combination linked to the second entity object due to a selection of the second entity title.

The third GUI system can also include a third GUI circuitry configured to output a first input field configured to receive a search term, such as field 308c. The third GUI circuitry can also be configured to output a second input field configured to receive a bid amount for the search term, such as field 310c. The search term can be received from a voice command input, a keyboard input, a keypad input, or a gesture selection input on the at least one word or word combination, such as a selection from a list of suggested search terms 312c. The gesture selection input can be a click on the at least one word or word combination of the list. The bid amount may be received from a voice command input, a keyboard input, a keypad input, or a gesture selection input on the outputted cost (such as the outputted cost 311c).

In another example, the third GUI circuitry can also be configured to output a minimum bid upon receiving the search term. Also, in another example, the third GUI circuitry can also be further configured to output an exclusivity bid amount upon receiving the search term. The exclusivity bid amount being an amount required to make a link to the search term from the entity object to an exclusive link. The third GUI circuitry can also be further configured to receive a request for an exclusive link to the search term from the entity object. In such an example, a fourth GUI circuitry of the third GUI system can be configured to communicate the exclusivity request to the third GUI system over a network.

The third GUI system can also include the fourth GUI circuitry, which can be configured to generate a first input field configured to receive an entity name of an entity associated with an entity object, in the background, from a selection of a search term in one of the lists 306c or 312c, for example. The fourth GUI circuitry can also be configured to output a second input field (such as field 314c) configured to receive a request to execute the inputted bid and link the inputted search term and the inputted entity name. This input field (e.g., field 314c) can also be configured to send the request to execute the bid and link the inputted search term and the inputted entity, to the third GUI system over the network. In another example, the fourth GUI circuitry can also be configured to output a third input field (not depicted) that can be configured to receive an exclusivity request for an exclusive link to the search term from the entity object. Also, in another example, the second input field (e.g., field 314c) can also be configured to send the exclusivity request to the third GUI system over the network. In FIG. 3c, the second field outputted by the fourth GUI circuitry is a button.

The third GUI system can also include a fifth GUI circuitry that is configured to output at least one suggested word or word combination for linking to the entity object, such as the list of suggested words and word combinations 312c. In another example, the fifth GUI circuitry can also be configured to output an indication of an exclusivity right for the at least one suggested word or word combination and a corresponding suggested cost for the exclusivity right (not depicted). A cost or suggested cost and an exclusivity label corresponding to the cost or the suggested cost can be outputted alongside any listing of a search term or even a listing of an entity object in some examples. Also, for example, the second GUI circuitry can be further configured to output a cost for a linked search term, an indication of an exclusivity right for the linked search term (such as an exclusivity label), or both.

The third GUI system can also include a sixth GUI circuitry that is configured to output an input field configured to receive an additional bid amount for additional functionality associated with potential results resulting from a selected search term (such as field similar to field 310d in FIG. 3d).

FIG. 3d illustrates an example GUI configured to provide an interface for additional bidding on additional functionality associated with a link between a search term and an entity search result. As depicted in FIG. 3d, a search term can include one or more words. A server, such as the account server 102, can provide information over a network to an advertiser client device that interprets the information to render the GUI 300d. The GUI 300d can be rendered on a client side application, such as a web browser. The server that provides such information can include or be communicatively coupled with a fourth GUI system stored in a non-transitory device executable by processor circuitry. The fourth GUI system can include first GUI circuitry configured to output entity object information, the entity object information including an entity title (such as entity title 304d) and an entity sponsor of an entity object (such as entity sponsor 302d). The field containing the entity title 304d in FIG. 3d may be a dropdown menu with more than one indication of entities linked to the sponsor.

The fourth GUI system can also include second GUI circuitry configured to output at least one word or word combination linked to the entity object, such as the list of linked search terms 306d. In FIG. 3d, six search terms are selected and each of the selected six search terms has an associated bid beside it. All the search terms in the list 306d may be selected by clicking on the button 308d. Additional bids associated with additional functionality can be inputted with respect to the search terms selected in the list 306d. Such additional bids can be made in sub-fields of the field 310d. The button 312d can be clicked on to send, over the network, a request to the fourth GUI system to execute the additional bids related to the selected search terms. The additional bids can include a bid associated with adding ad content to an entity tray of the corresponding entity object, when the entity tray results from a purchased search query. The additional bids can also include a bid associated with adding ad content to a plurality of sub-GUIs within the entity tray, when the entity tray results from a purchased search query. The sub-GUIs may include a summary card and a “more” card of the entity tray. The additional bids can also include a bid associated with adding ad content to a host operating system GUI part, when the GUI part results from a purchased search query. Also, the additional bids can also include a bid associated with adding ad content to a transition between entity object search results associated with a purchased query, or include a bid associated with adding ad content to a transition between entity object sub-GUIs within an entity tray of the entity object, when the entity tray results from a purchased search query.

FIG. 3e illustrates an example graphical user interface (GUI) 300e configured to provide an interface for selecting and then possibly bidding on entities at a later stage. A server, such as the account server 102, can provide information over a network to an advertiser client device that interprets the information to render the GUI 300e. The GUI 300e can be rendered on a client side application, such as a web browser. Such a GUI can be associated with circuitry of a GUI system on the server that is configured to output an advertiser name of an advertiser, such as the sponsor name 302e. The GUI system can also include circuitry configured to output an input field, such as the field 304e, to receive queries for an entity. As an advertiser enters such an entity input, a suggested entity may appear (such as illustrated by the drop-down list 306e). The GUI system can also include circuitry configured to output an input field, such as the field 307e, to receive a request to select the inputted entity, such as for sponsorship. The selected entities may be outputted as well, such as illustrated by field 308e. The output field also may include or be combined with a field for deselecting entities. For example, as illustrated in FIG. 3e, when a checkbox (such as 309e) next to an entity is selected and then a user selects a deselect button (such as 310e) that entity can be deselected or at least the server receives a request to deselect the entity.

As illustrated, the fields 307e and 310e are clickable buttons. Any of the aforementioned input fields and any other input field described herein can receive a user input through a voice command input, a keyboard input, a keypad input, a gesture input, or any combination thereof. Also, in selecting on an entity, an advertiser may also be selecting all related entities. The entities may be related through database links. In an example, an advertiser may select to bid on all entities related to the entity entered in field 304e, by selecting checkbox 312e.

FIG. 3f illustrates an example graphical user interface (GUI) 300f configured to provide an interface for selecting and then possibly bidding on search terms at a later stage. A server, such as the account server 102, can provide information over a network to an advertiser client device that interprets the information to render the GUI 300f. The GUI 300f can be rendered on a client side application, such as a web browser. Such a GUI can be associated with circuitry of a GUI system on the server that is configured to output an advertiser name of an advertiser, such as the sponsor name 302f. The GUI system can also include circuitry configured to output an input field, such as the field 304f, to receive text query inputs. As an advertiser enters a query input, a suggested keyword may appear (such as illustrated by the drop-down list 306f). The GUI system can also include circuitry configured to output an input field, such as the field 307f, to receive a request to select the inputted search term, such as for sponsorship. The selected search terms may be outputted as well, such as illustrated by field 308f. The output field also may include or be combined with a field for deselecting search terms. For example, as illustrated in FIG. 3f, when a checkbox (such as 309f) next to a term is selected and then a user selects a deselect button (such as 310f) that term can be deselected or at least the server receives a request to deselect the term.

As illustrated, the fields 307f and 310f are clickable buttons. Any of the aforementioned input fields and any other input field described herein can receive a user input through a voice command input, a keyboard input, a keypad input, a gesture input, or any combination thereof. Also, in selecting on a search term, an advertiser may also be selecting all related search terms. The search terms may be related through database links. In an example, an advertiser may select to bid on all search terms related to the search term entered in field 304f, by selecting checkbox 312f.

FIG. 3g illustrates an example graphical user interface (GUI) 300g configured to provide an interface for selecting and then possibly bidding on search terms and entities at a later stage. GUI 300g is a hybrid of GUIs 300e and 300f. GUI 300g can be associated with circuitry of a GUI system on the server that is configured to output an advertiser name of an advertiser, such as the sponsor name 302g. The GUI system can also include circuitry configured to output an input field, such as the field 304g, to receive a text query. As an advertiser enters a query, a suggested keyword or entity may appear (such as illustrated by the drop-down list 306g). The GUI system can also include circuitry configured to output an input field, such as the field 307g, to receive a request to select the inputted search term or entity, such as for sponsorship. The selected search terms may be outputted as well, such as illustrated by field 308g. Keywords are labeled with “(KW)” and entities are labeled with “(E)” in FIG. 3g. The output field also may include or be combined with a field for deselecting search terms or entities. For example, as illustrated in FIG. 3g, when a checkbox (such as 309g) next to a term or an entity is selected and then a user selects a deselect button (such as 310g) that term or entity can be deselected or at least the server receives a request to deselect the term or entity. As illustrated, the fields 307g and 310g are clickable buttons. Also, an advertiser may select to bid on all search terms and/or entities related to the search term or entity entered in field 304g.

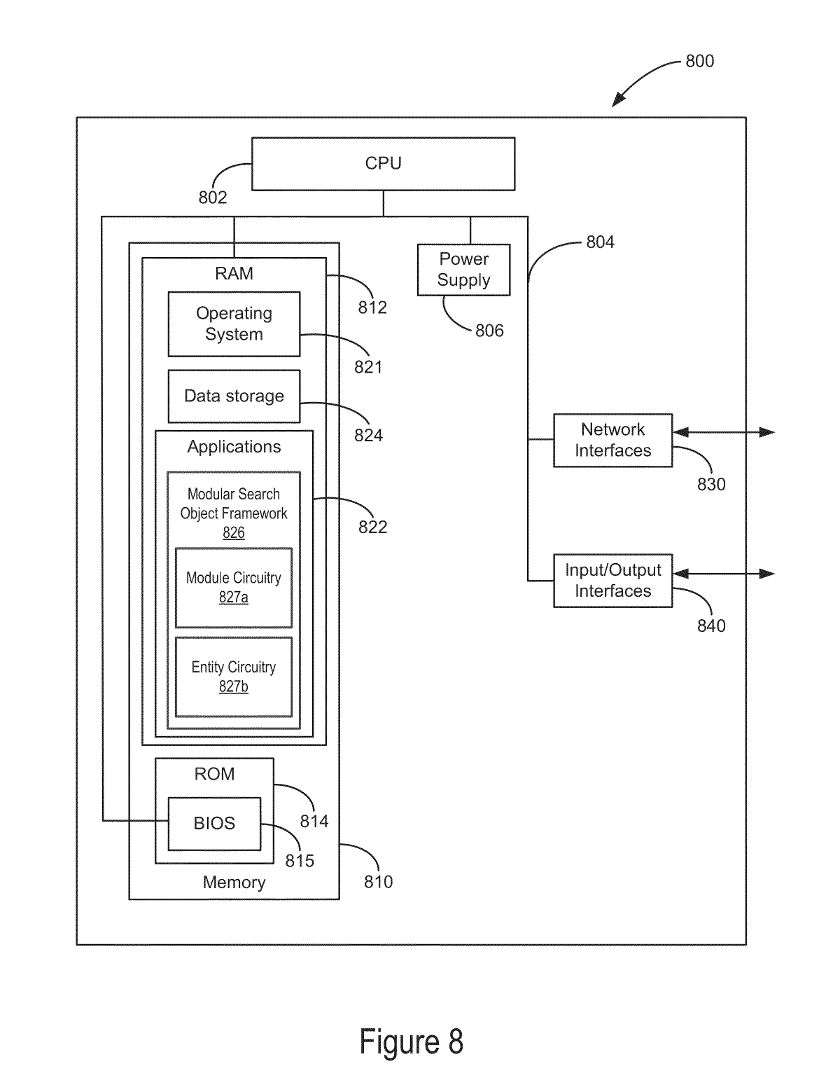

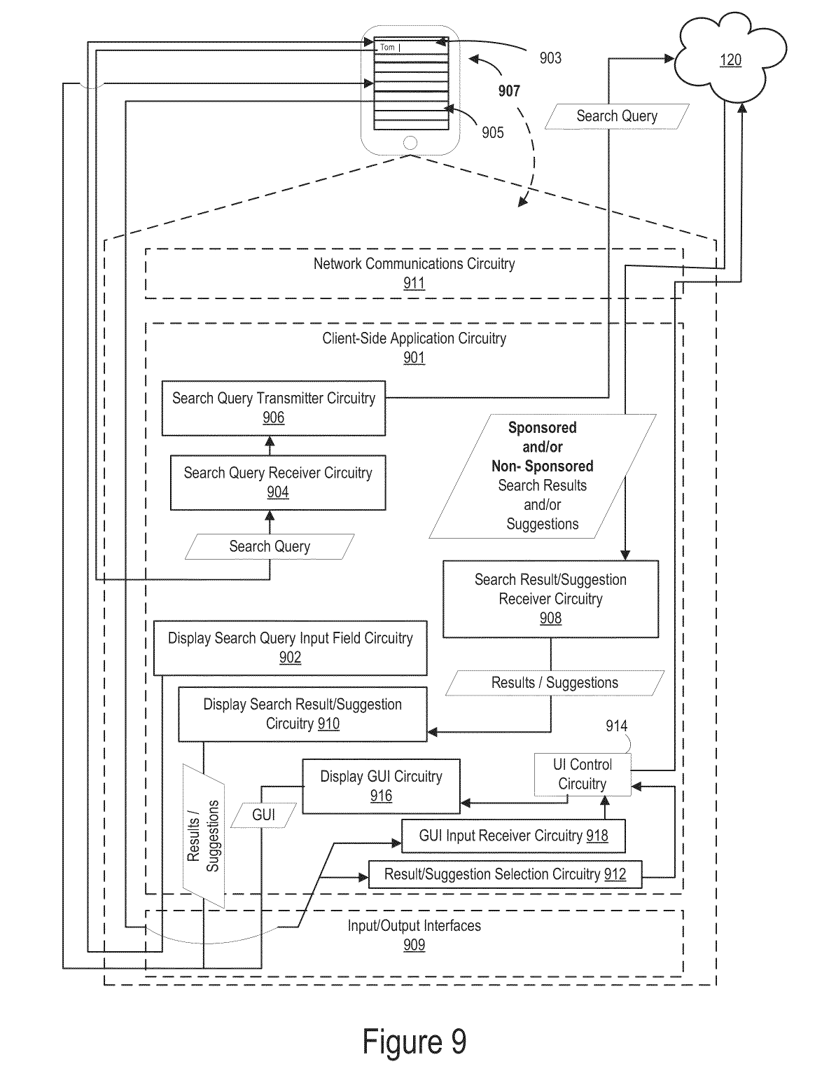

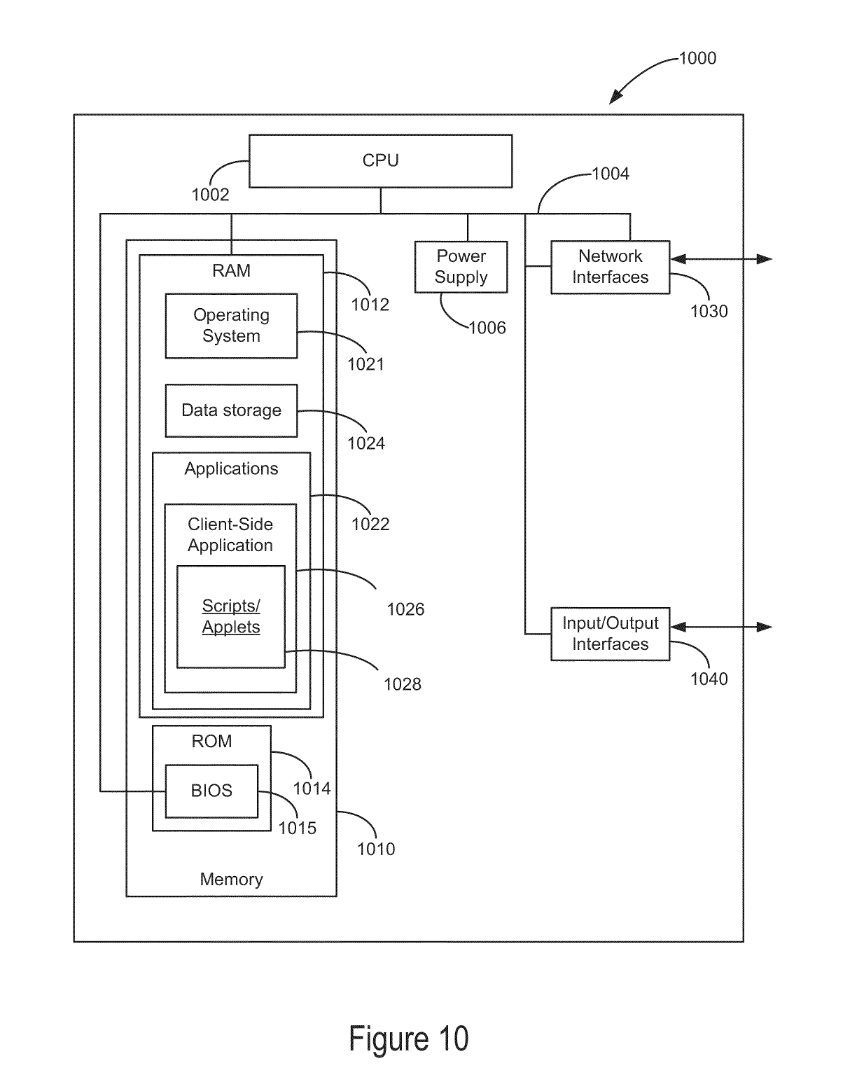

FIG. 4 illustrates a block diagram of example circuitry of a server of an example system that can provide aspects of the module search object framework, such as the modular search framework server 116 illustrated in FIG. 1. FIG. 4 also shows a client device 401 (such as any of the client devices 124-128 of FIG. 1, device 907 of FIG. 9, or device 1000 of FIG. 10) communicatively coupled to a server 400, over the network 120. In an example, the server 400 may include one or more servers, such as the modular search framework server 116, the search engine server 106, the server 800 in FIG. 8, or any combination thereof.

The server 400 includes processor circuitry 402 (such as central processing unit (CPU) 802 of FIG. 8) and a system stored in a non-transitory medium 404 (such as memory 810) executable by the processor circuitry. The system is configured to provide several aspects of the framework. The server 400 can also include entity search engine circuitry 403 configured to execute a search query on an entity database such as an entity database included in the framework database 115 in FIG. 1. In another example, the processor circuitry 402 can take on the tasks of the entity search engine circuitry 403. In yet another example, the entity search engine circuitry 403 can be a separate CPU dedicated and configured to maximize entity search queries.

The system includes network communications circuitry 406 (such as circuitry included in the network interfaces 830) and framework circuitry 408 (such as circuitry included in the modular search object framework 826). The network communications circuitry 406 and the framework circuitry are communicatively coupled by circuitry. In this disclosure, circuitry may include circuits connected wirelessly as well as circuits connected by hardware, such as wires. The network communications circuitry 406 may be configured to communicatively couple the system to the client device 401 over the network 120. This for example allows an entity section provided by the server 400 to be displayed by a client-side application installed on the client device 401.

The system may include input/output circuitry configured to communicatively couple the network communications circuitry 406 (further described below) to the framework circuitry 408 communicatively coupled to the interface circuitry. The framework circuitry may include entity circuitry including people, places, and things circuitry. The people circuitry may include particular person entity circuitries each including person sponsor circuitry. The places circuitry may include particular places entity circuitries each including place sponsor circuitry. The things circuitry may include particular things entity circuitries each including thing sponsor circuitry. Any given person, place, and thing sponsor circuitry may include an indicator of a sponsor stored on the circuitry, an indicator of a linked query, and whether that linked query was purchased and the cost of the purchase. Also, in another example, any given person, place, and thing sponsor circuitry may include an indicator of whether the linked query is exclusive to a corresponding entity object. Module circuitry (further described below), which interfaces the entity circuitry, may include monetization circuitry including respective sub-circuitry corresponding to each given person, place, and thing sponsor circuitry.

In other words, the framework circuitry 408 includes module circuitry 410 (such as module circuitry 827a), entity circuitry 412 (such as entity circuitry 827b), inter-module interface circuitry 414, inter-entity interface circuitry 416, and inter-framework interface circuitry 418. The inter-module interface circuitry 414 may be configured to communicatively couple any module circuitry of the module circuitry 410. For example, this circuitry 414 may at least communicatively couple entity GUI module circuitry, such as tray module circuitry 420, to one or more other circuitry of the module circuitry 410.

The inter-framework interface circuitry 418 may be configured to communicatively couple at least one entity circuitry of the entity circuitry 412 to any one of the plurality of module circuitry in the module circuitry 410, such as coupling any one of the entity circuitry to the tray module circuitry 420. For the example sections illustrated in FIGS. 11b-15b, the tray module circuitry may be configured to interact with the at least one entity circuitry to output an interactive entity section to a page view for a corresponding entity. Also, in such an example, the interactive section may include a plurality of moveable visual objects with information relevant to the corresponding entity. Also, in such an example, the plurality of moveable visual objects may be moveable within the interactive entity section. These functions can be implemented via the interoperating of the sub-circuitry of the module circuitry 410 and the entity circuitry 412.

Also, these moveable objects and associated functionality can be provided by any type of module circuitry and entity circuitry interoperating by the coupling provided by the inter-framework interface circuitry 418. In an example, the moveable visual objects may be cards. Also, the cards may have rounded corners as depicted in FIG. 11a-15b. A card of such cards may include a miniature tray of miniature cards within the card, and the miniature cards may include information relevant to the entity, as depicted in FIG. 12a. Also, the moveable object may include links for navigation between entities, and such objects may be overlapping, such as where a first overlapping object is moveable to view at least part of a second object beneath the first object. Also, the moveable visual objects may be adjacent to or abutting one other object of the moveable objects. These functions can be implemented via the interoperating of the sub-circuitry of the module circuitry 410 and the entity circuitry 412.

Also, beneficial functionality, such as movement by an object of the plurality of moveable objects being seamless without unintentional visual artifacts, can be due to close coupling of the circuitry of the framework circuitry 408. Additionally, close coupling between client-side circuitry of the framework circuitry installed on the client device 401 and native operating system circuitry of the client device, circuitry of a client-side application installed on the client device, or both, can improve such beneficial functionality as well. Code can be communicated from the server 400 to the client device 401, which provides addition to and configuration of the client-side circuitry of the framework circuitry for the client device. For example, circuitry within client device 907 of FIG. 9 may be added to or altered according to such code communicated from the server 400. The code may include objects representative of part of the framework circuitry 408.

The inter-entity interface circuitry 416 may be configured to communicatively couple at least one of the plurality of entity circuitry to one or more other of the plurality of entity circuitry, of the entity circuitry 412. The inter-entity interface circuitry 416 is communicatively coupled to the inter-module interface circuitry 414 by the inter-framework interface circuitry 418. These interconnections can provide a basis for the linking between entities as illustrated in FIGS. 11a-15b and corresponding text, and associating certain module GUIs with certain entities.

The module circuitry 410 can include at least one module circuitry, such as the tray module circuitry 420. Other examples of module circuitry within the module circuitry 410 can include entity search result circuitry, search suggestion circuitry, non-entity search result circuitry (such as webpage search result circuitry), maps circuitry, and much more. Such circuitry can provide the various structures and operations illustrated in FIGS. 2 and 11a-15b. As illustrated by FIG. 4, a hierarchy of module circuitry within the circuitry 410 can be extensive. For example, as depicted, module circuitry, such as the tray module circuitry 420, can include sub-module circuitry, and that sub-module circuitry can each have sub-module circuitry of its own. For example, a majority of the module circuitry of the circuitry 410 (whether or not a sub-module circuitry) can each at least include sub-module circuitry configuring that circuitry and configuring one or more GUIs provided by that circuitry. The example organization of the circuitry of the module circuitry 410 coincides with the arrangement of GUIs and sub-GUIs illustrated in FIGS. 11a-15b. However, other arrangements could coincide with the depicted GUIs as well.

The tray circuitry 420 may include the summary circuitry, the tray configuration circuitry that may include the tray GUI configuration circuitry, and the “more” circuitry associated with the “more” GUI depicted in FIG. 12a, for example. Also, as illustrated in FIG. 4, the tray circuitry 420 includes other sub-circuitry for other functions imaginable by the framework related to a tray object. In FIG. 4, the summary circuitry, such as the respective circuitry providing the summary GUI in FIG. 11b, includes configuration circuitry such as circuitry for the configuration of the summary GUI, analytics circuitry, and monetization circuitry. The analytics circuitry may provide for at least part of the information possibly intended to be viewed by a user and may interact with aspects of an analytics server, such as analytics server 118 to improve feedback and the resulting content at least partially based on the feedback. Several GUIs of the framework may be associated with the analytics circuitry of the summary circuitry or other analytics circuitry of module circuitry 410. Such GUIs are likely to incorporate predictively desired information to audience members of the framework, which can be predicted in part by analytics. The monetization circuitry may be configured to record and communicate the user interaction with an interactive section (such as the entity tray) to sponsor circuitry corresponding to the interactive entity section. The sponsor circuitry depicted in people circuitry 430, places circuitry 432, and things circuitry may be configured to determine and record a fee for the interaction with the interactive entity section. As illustrated in FIG. 4, each sub-circuitry of the module circuitry 410 may include monetization circuitry for monetization of corresponding framework aspects and features. Also, as illustrated in FIG. 4, each individual entity circuitry of the entity circuitry 412 may include its own sponsor circuitry. In an example, the monetization circuitry of the various circuitry of the module circuitry 410 and the sponsor circuitry of individual entity circuitry of the entity circuitry 412 can be tightly coupled to enhance entity sponsorship and monetization processing for aspects and features of the framework selected for sponsorship and monetization.

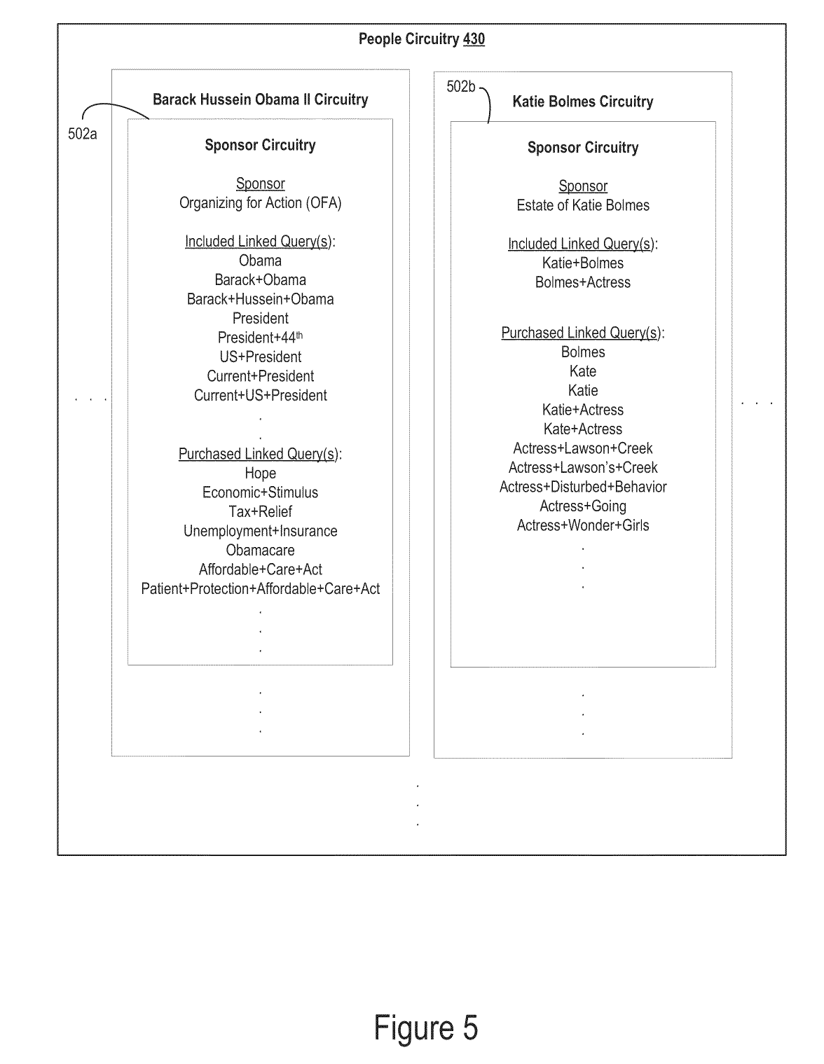

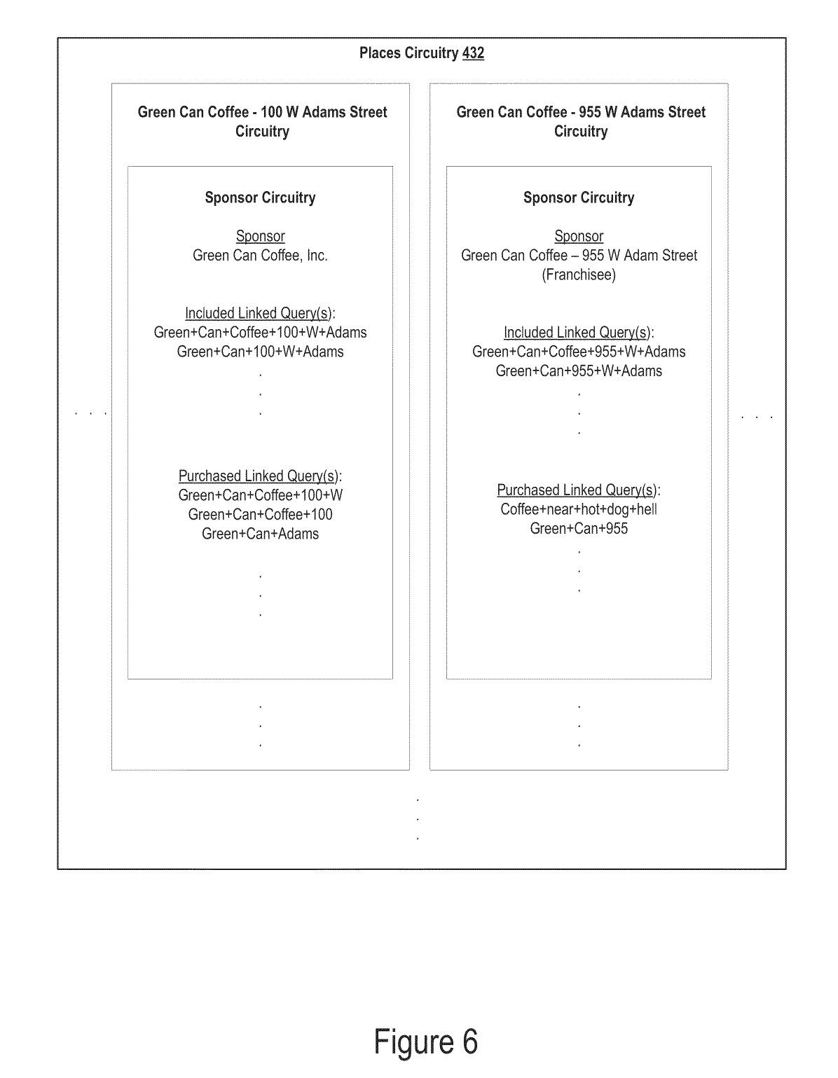

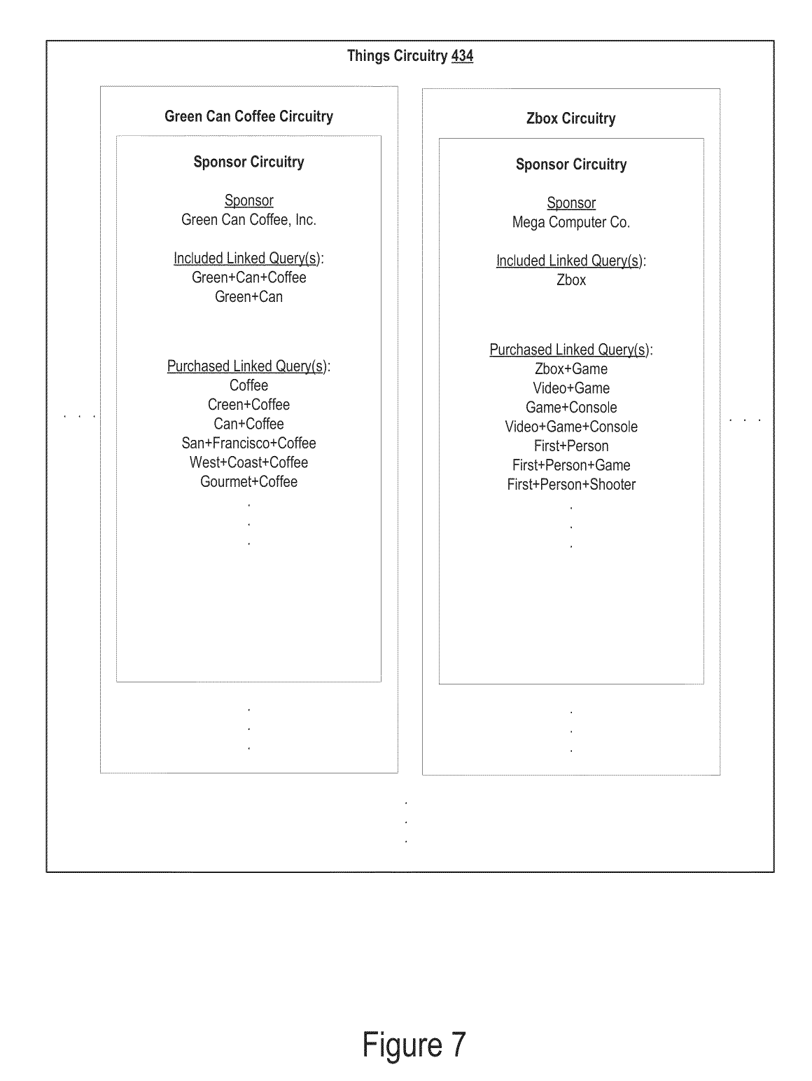

FIGS. 5-7 illustrate block diagrams of example entity sub-circuitries of a server of an example system that can provide aspects of the module search object framework, such as a modular search framework server 400. FIG. 5 illustrates possible sub-circuitries of circuitry for specific person entities Barack Hussein Obama II and Katie Bolmes. FIG. 6 illustrates possible sub-circuitries of circuitry for specific place entities that includes two actual locations of Green Can Coffee cafes. FIG. 7 illustrates possible sub-circuitries of circuitry for specific thing entities Green Can Coffee and zBox. These sub-circuitries are embedded in respective circuitries (people circuitry 430, places circuitry 432, and things circuitry 434 of server 400). The sub-circuitries include respective sponsor sub-circuitries 502a & 502b, 602a & 602b, and 702a & 702b. These figures depict the sponsor sub-circuitries 502a & 502b, 602a & 602b, and 702a & 702b including parts for storing a given sponsor, respective linked search terms that were linked to the given entity by default, and respective additional linked search terms that were purchased by the given sponsor. The search terms under the label “included linked query(s)” are possible default terms. Although, such terms may change over time and are not necessarily permanent. Determination of such terms may be according to analytics data, such as data fed back from the analytics server 118. The search terms under the label “purchased linked query(s)” are additional terms added by bids. In another example, the search terms under the label “purchased linked query(s)” may be additional terms added by bids to be exclusive to the given entity. For example, an advertiser can bid for exclusive rights to a search term.

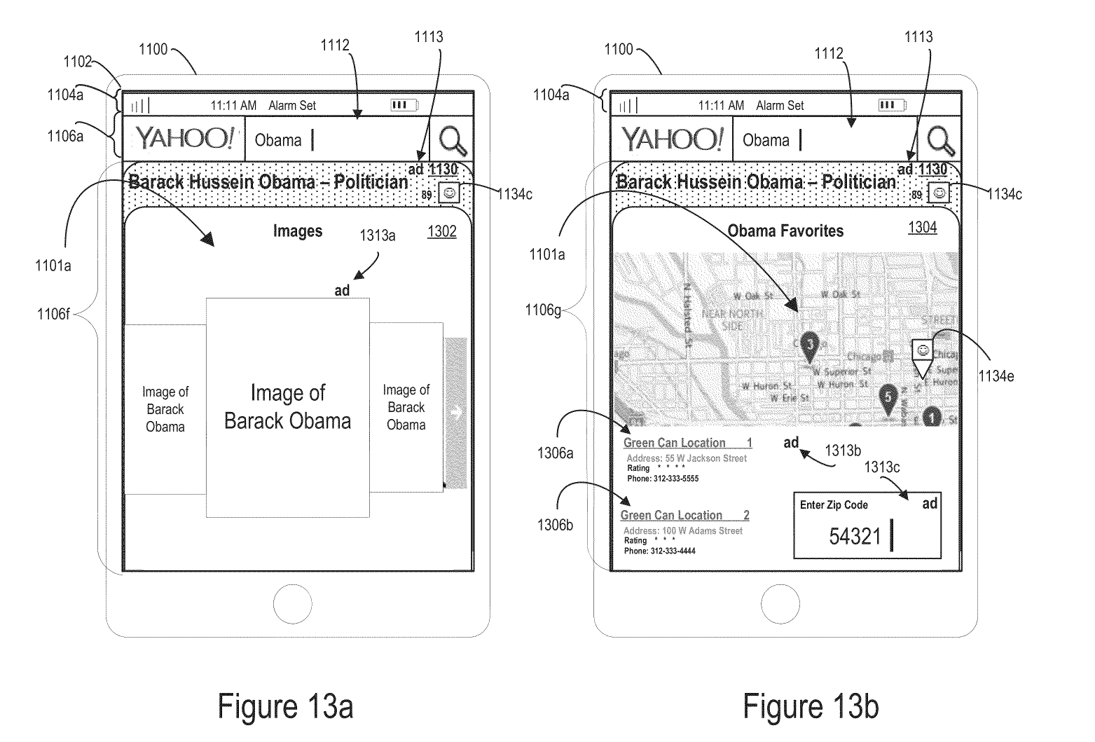

Referring back to FIG. 4, the entity search result circuitry 422 may provide various functionalities and structures associated with retrieving and displaying sponsored and non-sponsored entity search results, such as the sponsored and non-sponsored entity search results depicted in FIGS. 11a. The search suggestion circuitry may provide various functionalities and structures associated with retrieving and displaying sponsored and non-sponsored search suggestions, such as the search suggestions depicted in FIG. 11a. The webpage search result circuitry 426 may provide various functionalities and structures associated with retrieving and displaying webpage search results, such as the sponsored and non-sponsored webpage search results depicted in FIG. 12b. For the purposes of this disclosure, webpage search results are an example of non-entity search results. Other example, non-entity search results are image search results associating images ambiguously with a search query. Entity search results are results that include informational objects for a specific entity, such as a particular person, place, or thing. With places and things, there are sub-entities. Entities will be explained in more detail at another part of this disclosure. The maps circuitry 428 may provide various functionalities and structures associated with retrieving and displaying maps based search results, such as the map search results depicted in FIG. 13b. The maps circuitry 428 may include or be associated with navigation circuitry of the module circuitry 410 (such as circuitry including circuitry for discovering routes and device geographic positioning). The social media circuitry 429 may provide various functionalities and structures, such as GUI elements, associated with presenting social media information and providing social media applications, such as social media widgets. The social media circuitry 429 may be communicatively coupled over a network with servers of social media provides, such as TUMBLR, LINKEDIN, GOOGLE PLUS, FACEBOOK, TWITTER, and the like. Information feeds and applications provided by the social media servers can be administrated by the social media circuitry for execution on sponsored and non-sponsored entity trays and GUIs. The social media features as well as any other features described herein may be monetized, and the social media circuitry 429 may include its own circuitry dedicated to monetization. Examples of social media widgets and information are illustrated in FIGS. 11a-15b. See GUI elements 1134c-1134i and 1218c illustrated in FIGS. 11a-15b.

As mentioned, each of the module circuitry may include sub-module circuitry, such as corresponding user interface circuitry, configuration circuitry, analytics circuitry, monetization circuitry, data processing circuitry, data storage circuitry, data retrieval circuitry, navigation circuitry, or any combination thereof. The examples of module circuitry described herein and shown in FIG. 4 are merely illustrative of the expansiveness of the framework.

The entity circuitry 412 include various types of entity circuitry, including people circuitry 430, place circuitry 432, and thing circuitry 434. Individual entity circuitry with the people circuitry 430, place circuitry 432, and thing circuitry 434 can include respective sponsor circuitry, such as depicted in FIG. 4. In an example, control of an online entity module through one of the people circuitry 430, place circuitry 432, and thing circuitry 434, such as a business module or a module for a specific location of that business, can be purchased through sponsorship. In an example, sponsorship can go to the highest bidder. In another example, sponsorship can go to the highest bidder who also has a legitimate claim to that entity module. In yet another example, sponsorship can only be obtained and/or purchased by the actual entity or at least a legal representative of that entity. As it can be imagined, an entity entitled to claim a given online entity module can become complex, so some example implementations can utilize any combination of the aforementioned rules for claiming an entity. For example, in one scenario, only the legal entity Green Can Coffee can purchase sponsorship of the Green Can Coffee the thing entity, but where Green Can Coffee is a franchise, each location of Green Can Coffee may be purchased by its respective franchisee and/or the franchisor Green Can Coffee. The franchisee and franchisor could compete in a bidding process or just work out who is going to pay for the sponsorship themselves. Other complications in claiming an entity may arise, including entities that are not owned. For example, a historical entity, such as the Holy Roman Empire, does not have an owner, so in some scenarios such an entity may go to the highest bidder. For example, Green Can Coffee may identity that coffee drinkers are interested in European History, so it may be worthwhile for Green Can Coffee to purchase sponsorship of the Holy Roman Empire module. The sponsorship could also be shared with another entity, so that more than one entity can utilized ad time on the Holy Roman Empire module.

In a scenario, the framework service provider of the entity modules may maintain a degree of control over the content presented by an entity module. For example, the provider may regulate the amount of irrelevant content added to a GUI of an entity module. Also, the look and feel of module to some degree may be maintained by the provider to maintain consistency of the look and feel of the environment hosting the entity modules. Also, the provider control can allow for the provider to prevent content from becoming stale. For example, if can entity does not maintain its content regularly, a provider can predict content a user and/or a sponsor wants to be presented by a GUI of an entity module and provide such predicted content instead of the stale content.

Referring back to FIG. 4, the people circuitry 430 includes circuitry for each particular person that can be identified as an entity by the framework. A particular person can be an actual living person or a person who has passed away. Well-known people, who are often searched online, such as celebrities, may be automatically inputted into the framework and hence circuits are generated for those people automatically. Less known people, such as an ordinary Joe starting a small business, may submit an application for circuitry to be generated for themselves or a business and/or product they wish to market through the framework. A particular person can also be a character in a fictional work. For fictional characters, there may be a plurality of entities for a known character. For example, the character Supermom may have entity circuitry for each entered iteration of the Supermom character inputted into the framework, such as a plurality of Supermoms from the different Supermom movies and television series, and a plurality of Supermoms from the different versions of the Supermom comic books. A person entity becomes identifiable when a corresponding entity has been submitted and accepted by the framework. At that point, circuitry can be generated for that person entity. The front end for the modular search framework server 116 and/or the account server 102 can facilitate entry of entities, such as people entities.

The place circuitry 432 includes circuitry for each particular location that can be identified as an entity by the framework. A particular location can be an address, a global positioning point, an actual location not having an address, or combination thereof. Actual locations not having an address can be submitted through an application process, such as an obscure park. Locations that are commonly searched without an address can be automatically inputted into the system as circuits, such as a national park. In other words, well-known places, which are often searched online, such as landmarks, government administrated parks, cities, countries, and even well-known bodies of water, may be automatically inputted into the framework and hence circuits are generated for those places automatically. Less known places, such as an ordinary parking lot without an address, may be submitted via an application for circuitry to be generated for that place. Businesses and products may be marketed through a place entity, for example. Places can be any geographic entity, whether that entity is fictional, non-fictional, still in existence, historical, or some combination thereof. For fictional places, there may be a plurality of entities for a known fictional place. For example, each iteration of Atlantis used in fictional works may have its own entity circuit. A place entity becomes identifiable when a corresponding entity has been submitted and accepted by the framework. At that point, circuitry can be generated for that place entity. A front end for the modular search framework server 116 and/or the account server 102 can facilitate entry of entities, such as place entities.

The thing circuitry 434 includes circuitry for each particular thing that can be identified as an entity by the framework. A particular organization, product, service, named organism (such as a pet or famous circus animal), can be a thing entity. Thing entities can overlap with places entities and fictional character entities; for example, a geographic location like the dark side of the moon may be a thing as well. Also, for example, the Wizard of Oy may be a thing entity (such as a movie entity), and a character entity, such as the Wizard of Oy the character in the original movie production. Also, there may be several iterations of a thing. To continue with the Wizard of Oy theme, there may be several well-known productions of this movie in a live theatre format. Well-known things, which are often searched online, such as movies, mass manufactured products, and large companies, may be automatically inputted into the framework and hence circuits are generated for those things automatically. Less known things, such as a new product developed by an ordinary Joe, may be submitted via an application for circuitry to be generated for that thing. Services and products may be marketed through a thing entity, for example. Things can be almost any unambiguous thing that can be claimed. Things can be fictional, non-fictional, still in existence, historical, or some combination thereof. A thing entity becomes identifiable when a corresponding entity has been submitted and accepted by the framework. At that point, circuitry can be generated for that thing entity. A front end for the modular search framework server 116 and/or the account server 102 can facilitate entry of entities, such as thing entities.

Each particular person, place, or thing circuitry of the entity circuitry 412 can include and provide respective data models for gathering, maintaining, and entering information on that corresponding entity. The data models can include sponsorship and monetization models as well. These data models can also act as an interface for data requested by various operations provided by the module circuitry 410. Each particular entity circuitry may also include logic for facilitating operations between module circuitry of the circuitry 410 and databases storing information on entities, such as the entity database with the framework database 115 in FIG. 1. In other words, such entity circuitry may act a middleware between functions and data of the framework. Given this middleware functionality, module circuitry, such as the summary module circuitry, does not need to include sub-circuitry for every entity in the system. When module circuitry is called for an entity, that module circuitry can combine with the entity circuitry via communications, instead of actual circuitry per entity hardwired into each module.

Regarding the example entity screen in FIG. 11b, various functions are being called which are provided by the module circuitry 410, such as functions of the summary module circuitry. For a function of the summary module circuitry to retrieve information on Green Can Coffee the thing, the function communicates with the particular entity circuitry for Green Can Coffee the thing. This particular entity circuitry may have the information on Green Can Coffee cached or permanently stored within its circuitry or may request the information from a database, such as the framework database 115, which can be specifically configured for the modular search framework server 116, and/or the content database 114 or ad database 110.

FIG. 8 is a block diagram of an example electronic device 800 that can implement server-side aspects of and related to example aspects of the framework. For example, the electronic device 800 can be a device that can implement the modular search framework server 116 of FIG. 1 or the server 400 of FIG. 4. The electronic device 800 can include a CPU 802, memory 810, a power supply 806, and input/output components, such as network interfaces 830 and input/output interfaces 840, and a communication bus 804 that connects the aforementioned elements of the electronic device. The network interfaces 830 can include a receiver and a transmitter (or a transceiver), and an antenna for wireless communications. The CPU 802 can be any type of data processing device, such as a central processing unit (CPU). Also, for example, the CPU 802 can be central processing logic.

The memory 810, which can include random access memory (RAM) 812 or read-only memory (ROM) 814, can be enabled by memory devices. The RAM 812 can store data and instructions defining an operating system 821, data storage 824, and applications 822. The applications 822 can include a modular search object framework 826 (such as framework circuitry 408 illustrated in FIG. 4), which can include module circuitry 827a (such as module circuitry 410) and entity circuitry 827b (such as entity circuitry 412). The applications 822 may include hardware (such as circuits and/or microprocessors), firmware, software, or any combination thereof. The ROM 814 can include basic input/output system (BIOS) 815 of the electronic device 800.

The power supply 806 contains power components, and facilitates supply and management of power to the electronic device 800. The input/output components can include the interfaces for facilitating communication between any components of the electronic device 800, components of external devices (such as components of other devices of the information system 100), and end users. For example, such components can include a network card that is an integration of a receiver, a transmitter, and I/O interfaces, such as input/output interfaces 840. The I/O components, such as I/O interfaces 840, can include user interfaces such as monitors, keyboards, touchscreens, microphones, and speakers. Further, some of the I/O components, such as I/O interfaces 840, and the bus 804 can facilitate communication between components of the electronic device 800, and can ease processing performed by the CPU 802.

FIG. 9 illustrates a block diagram of example circuitry of a client device of an example system that can provide aspects of the module search object framework, such as any client device of the system illustrated in FIGS. 1 and 10. For example, FIG. 9 illustrates a block diagram of example circuitry of a client device 907 that can provide sponsored and non-sponsored entity search results, sponsored and non-sponsored non-entity search results, and sponsored and non-sponsored search suggestions within a section of a page view at least partially provided by a client-side aspect of the framework. The circuitry within the client device 907 can be part of and/or associated with a non-transitory medium executable by a processor of the client device. The circuitry can include input/output interfaces 909 (such as the input/output interfaces 1040 of FIG. 10). The circuitry can also include client-side application circuitry 901 (such as circuitry of the client-side application 1026 of FIG. 10). The circuitry can also include network communications circuitry 911 (such as network interfaces 1030 of FIG. 10).

The client-side application circuitry 901 can include first circuitry 904 configured to receive a search query from a search query input field 903 of the page view. Also, the client-side application can include circuitry 902 configured to display the search query input field. The search query can be inputted by a user via the search query input field 903 and a user input device (such as a user input device of the input/output interfaces 909). For example, input and output may be received via a touchscreen 905. The search query can include text, an image, a voice command, a gesture (such as a gesture from a user's eye, head, torso, arm, hand, finger or any combination thereof), or any combination thereof. The receiving of the search query can occur at a placeholder within a non-transient computer readable medium, such as a reserved memory slot for that placeholder in a memory device of the client device 907. The search query can be manifested in the computer readable medium by a physical state change at the placeholder within the medium.

The client-side application circuitry 901 can also include second circuitry 906 configured to communicate the search query to a search server (such as search engine server 106 of FIG. 1, a sponsored search server, and/or the modular search framework server 116) over a network (such as the network 120). The communicating of the search query can occur by a communications interface embedded or connected to the client device, such as a communications interface of the network communications circuitry 911. The communications interface can transform the changed physical state of the medium, which represents the search query, to an electromagnetic signal of any type for communications across a computer network link. The communications interface can be communicatively coupled to the non-transient computer readable medium and the search server. The search server and the client device 907 can be one or more computers connected over the network 120. The aforementioned communicative couplings and other such couplings described herein can be implemented by various types of wired and wireless connections. The communications across the couplings can be via any form of electromagnetic signal, such as an electrical signal, an optical signal, or any combination thereof. Also, in an example, the search server can be the search engine server 106, a sponsored search server, the modular search framework server 116, or any combination thereof.

The search query can be communicated with user information, wherein the user information includes demographic information associated with the user, psychographic information associated with the user, a real time geographic location of the user, or any combination thereof. The search query can be communicated over a network that is part of a cloud computing environment. The search server can also be part of the cloud computing environment. The search server can be communicatively coupled to a content server, an ad server, an analytics server, an account server, a sponsored search server, or any combination thereof (such any one or more of the servers of FIG. 1). Any of these parts may be part of the cloud computing environment.

The client-side application circuitry 901 can also include third circuitry 908 configured to receive entity and non-entity search results, such as entity and non-entity sponsored search results, from the search server according to the search query. This circuitry may also receive search suggestions from the server, such as sponsored search suggestions. Additionally or alternatively, search suggestions may be generated by a client-side circuit, such as by circuitry associated with the scripts and/or applets 1028 in FIG. 10. The receiving of the search result can occur by a communications interface embedded or connected to the client device, such as a communications interface of the network communications circuitry 911. The communications interface can transform an electromagnetic signal that represents the sponsored search into changed physical state of the non-transitory computer readable medium that represents the search result.

A search result can be determined at the search server according to the search query. This determination can be done by a non-entity or entity non-sponsored search results determiner circuitry and/or a non-entity or entity sponsored search results determiner circuitry hosted by the search server. A search result can also be determined according to the user information. The search result can also be determined from data from the content server, the ad server, the analytics server, the account server, the sponsored search server, or any combination thereof (such as any one or more of the servers of FIG. 1). The search result can include instructions associated with a sub-GUI that can extend out from, overlap, or both, a respective set of search results, such as illustrated in FIGS. 11a-15b. The instructions associated with the sub-GUI are hidden from view of the user, such as in the form of web browser readable and/or executable code.

The client-side application circuitry 901 can also include fourth circuitry 910 configured to display the entity and/or non-entity search results on the page view (such as the entity search results 1120-1124 and the non-entity search result 1116 in FIG. 11a). In such examples, a sponsored search result can be displayed first in a list of displayed search results. Also, the sponsored search result can abut a non-sponsored search result.

The displaying of the search result on a page view can occur on a display device of the touchscreen 905 already displaying the page view, wherein the display device is either embedded or connected to the client device 907. A graphics card or any other type of graphics processing device can transform the part of the computer readable medium representing the search result into an electromagnetic signal representing the sponsored search that can be communicated to the display device. At this point, the signal is rendered into a visual presentation by the display device. Any one of these technical functions can be implanted via an output device (such as an output device of the input/output interfaces 909) of the touchscreen 905.

The client-side application circuitry 901 can also include fifth circuitry 912 configured to receive a selection of a part of the search result or search suggestion. When a selection is for an entity search result, such as a sponsored entity search result, that selection can cause the displaying of an entity GUI and sub-GUIs. The receiving of the selection can occur at a placeholder within a non-transient computer readable medium, such as a reserved memory for that placeholder in a memory device of the client device 907. The selection can be manifested in the computer readable medium by a physical state change at the placeholder within the medium. The selection can be inputted by a user via an icon selection input field and a user input device (such as a user input device of the input/output interfaces 909). The selection can occur by a user clicking on, moving over, or touching a search result. The selection may occur by a tactile input, a voice command, a gesture (such as a gesture from a user's eye, head, torso, arm, hand, finger or any combination thereof), or any combination thereof.

The client-side application circuitry 901 can also include sixth circuitry 916 configured to display a GUI and/or sub-GUI associated with the search result (or a search suggestion). The displaying of the sub-GUI can occur in the same page view. The user interface can be proximate to the selected search result icon. The user interface can be within the same section of the search result. The user interface can abut the search result. The user interface can be immediately below the search result. The user interface can be immediately above the search result. The user interface can be immediately to a side of the search result. The user interface can be immediately kitty-corner of the search result. The user interface can be within a list of search results so that the user interface occurs below or above the search result and above or below, respectively, a search result initially below or above the search result. The search result initially below or above the search result could have been immediately below or above the search result. The displaying of the GUI or sub-GUI may cause the search result, which is immediately above or below the other search result, to move up or down according to the positioning of the GUI or the sub-GUI. This functionality is especially useful in the case of a sponsored search result.

The GUI or sub-GUI can present audio content, video content, textual content, graphical content, tactile content, any other type of human perceivable content, a web form, a video game, a link to a second page view, or any combination thereof. The GUI or sub-GUI can be displayed on or over the entire page view. The GUI or sub-GUI can be displayed on or over a majority of the page view. The sub-GUI can be displayed on or over a majority or the entirety of a page section containing the search result. In examples, where the GUI or the sub-GUI is displayed over a part of the page view, at least part of the GUI or sub-GUI can at least be partially transparent. In other examples, the one or more parts besides the user interface can be suppressed visually when the GUI or sub-GUI is displayed. The visual suppression can include blurring, reduction in size, reduction in brightness, reduction in sharpness, pixelization, filtering out one or more colors, or any combination thereof. These features can be modified to emphasize sponsored results and suggestions over non-sponsored results and suggestions, and emphasize sponsored entity GUIs over non-sponsored entity GUIs.

Examples of GUIs and sub-GUIs and their transitions are shown in FIGS. 11a-15b. Features of transitions can also be modified to emphasize sponsored transitions over non-sponsored transitions. A graphics card or any other type of graphics processing device can transform the part of the computer readable medium representing the GUI or sub-GUI into an electromagnetic signal representing the GUI or sub-GUI that can be communicated to the display device. At this point, the signal is rendered into a visual presentation by the display device. Any one of these technical functions can be implanted via an output device (such as an output device of the input/output interfaces 909).

The client-side application circuitry 901 can also include seventh circuitry 918 configured to receive a user input from a user input field of the GUI or sub-GUI. The receiving of the user input from the user input field of the GUI or sub-GUI can occur at a placeholder within a non-transient computer readable medium. Also, the receiving of the user input or any other receiving of user input described herein can occur via various known ways of receiving user input, such as the ways described herein. For example, the user input for the GUI or sub-GUI can be received and processed via a user input device (such as a user input device of the input/output interfaces 909). The user input can include text, an image, a voice command, a gesture (such as a gesture from a user's eye, head, torso, arm, hand, finger or any combination thereof), or any combination thereof.

The user input field can include a text box with one or more lines for entering text, a check box, radio button, a file select control for uploading a file, a reset button, a submit button, a drop-down list, a scrollable list, or any combination thereof. The user input field can also include a selectable image, an animated image, a fixed image, or any combination thereof. The user input field can be presented according to the search query, demographic information associated with the user, psychographic information associated with the user, a real time geographic location of the user, or any combination thereof.

The client-side application circuitry 901 can also include eighth circuitry 914 configured to initiate an action according to the received user input from the user input field of the GUI or sub-GUI. Aspects and features of and related to the action may be sponsored and/or monetized. The action can be manifested by one or more computer parts described herein, network parts described herein, any other known computer hardware, any other known computer software, and any combination thereof. For example, an action that occurs usually on the client-side can be implemented by a part of the client device 907. An action that occurs usually on the server-side can be implemented by a part of one of the servers described herein, such as the servers described with respect to FIG. 1.

The action can include displaying one or more sponsored GUIs or sub-GUIs and/or one or more non-sponsored GUIs or sub-GUIs, which can include or be associated with audio content, video content, textual content, graphical content, tactile content, any other type of human perceivable content, a web form, a user input field, a link to a another GUI or sub-GUI, such as one of another entity, a change to a state of a user input field (such as a location of the field, a size of the field, coloring of the field, brightness of the field, shape of the field, or another type of graphical makeup of the field, or any combination thereof), or any combination thereof. The action can include submission of the user input to a server. Such a submission can be used towards a transaction, such as a commercial transaction associated with sponsored content. The submission can be stored in a database. Also, the submission can be used to determine at least part of the displaying of the GUIs and sub-GUIs (in other words, the submission can be used as feedback).

FIG. 10 is a block diagram of an example electronic device 1000 that can implement client-side aspects of and related to aspects of the framework. For example, the electronic device 1000 can be any of the client devices described with respect to FIGS. 1 and 9, such as the audience client device 124. The electronic device 1000 can include a central processing unit (CPU) 1002, memory 1010, a power supply 1006, and input/output components, such as network interfaces 1030 and input/output interfaces 1040, and a communication bus 1004 that connects the aforementioned elements of the electronic device. The network interfaces 1030 can include a receiver and a transmitter (or a transceiver), and an antenna for wireless communications. The CPU 1002 can be any type of data processing device, such as a central processing unit (CPU). Also, for example, the CPU 1002 can be central processing logic; central processing logic may include hardware (such as circuits and/or microprocessors), firmware, software and/or combinations of each to perform functions or actions, and/or to cause a function or action from another component. Also, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 1010, which can include random access memory (RAM) 1012 or read-only memory (ROM) 1014, can be enabled by memory devices, such as a primary (directly accessible by the CPU) and/or a secondary (indirectly accessible by the CPU) storage device (such as flash memory, magnetic disk, optical disk).

The RAM 1012 can store data and instructions defining an operating system 1021, data storage 1024, and applications 1022, including the client-side application 1026 and the scripts and/or applets 1028 (such as scripts and/or applets adapted for framework client-side functions). The applications 1022 may include hardware (such as circuits and/or microprocessors), firmware, software, or any combination thereof. Example content provided by an application, such as the client-side application 1026, may include text, images, audio, video, or the like, which may be processed in the form of physical signals, such as electrical signals, for example, or may be stored in memory, as physical states, for example.

The ROM 1014 can include basic input/output system (BIOS) 1015 of the electronic device 1000. The power supply 1006 contains power components, and facilitates supply and management of power to the electronic device 1000. The input/output components can include various types of interfaces for facilitating communication between components of the electronic device 1000, components of external devices (such as components of other devices of the information system 100), and end users. For example, such components can include a network card that is an integration of a receiver, a transmitter, and I/O interfaces, such as input/output interfaces 1040. A network card, for example, can facilitate wired or wireless communication with other devices of a network. In cases of wireless communication, an antenna can facilitate such communication. The I/O components, such as I/O interfaces 1040, can include user interfaces such as monitors, keyboards, touchscreens, microphones, and speakers. Further, some of the I/O components, such as I/O interfaces 1040, and the bus 1004 can facilitate communication between components of the electronic device 1000, and can ease processing performed by the CPU 1002.

FIGS. 11a-15b illustrate screen presentations that can be provided by the modular search object framework. In FIGS. 11a-15b, the screen presentations are depicted as displayed on a display 1102 of a client mobile device 1100. However, screen presentations provided by examples of the framework can be adapted to display on a display associated with a personal computer, such as a desktop computer, or a smart television. The display 1102 includes a touchscreen configured to receive user input, such as touch gestures.

Within the screen presentations, illustrated are GUIs provided by the framework and GUIs provided by a native operating system and/or a native client-side application, such as a web browser. In an example, only GUIs provided by the framework can be monetized and sponsored. Alternatively, any GUI, whether provided by a native operating system and/or a native client-side application, can be monetized and sponsored. Also, even if the GUIs provided by a native operating system and/or a native client-side application are not monetized or sponsored, impressions and interactions with such GUIs can be tracked and communicated to an analytics server (such as analytics server 118 in FIG. 1) to be analyzed. Once processed into corresponding analytics data, such a server can provide feedback for affecting future serving of content, including sponsored and/or monetized content.

In FIG. 11a, section 1104a and touchscreen keyboard 1104b of the screen presentations are GUI parts provided by a native operating system of the client mobile device 1100. Section 1106a in FIGS. 11a-12a and 113a-15b of the screen presentations is a GUI part provided by the framework and/or a service provider associated with the framework, and sections 1106b-1106m in FIGS. 11a-15b include GUI parts provided by the framework. Also, for example, section 1108a in FIGS. 11b, 12a, and 14a-15b is a GUI part provided by the native client-side application executed on the client mobile device 1100. In the depicted examples, section 1108a is sponsored and partially provided by the framework. Sections provided by the native client-side application or operating system that are sponsored may have more restrictive rules for advertising, so that such advertising is not intrusive. Intrusiveness of such advertising within sections native to the client-side application or operating system may be an analytically determined by the analytics server. User interaction with a page view (such as a lack of dwell time or clicking) or the mobile device (such as resetting the display screen or even rebooting the device) can be tracked in a log and then the log can be communicated to the analytics server for intrusiveness analysis. This analysis can then be used by the framework to change such advertising if intrusiveness of the advertising exceeds an intrusiveness threshold.

In an example, GUI parts such as 1104b, 1106a, and 1108a may be hidden by the native operating system, the native client-side application, the framework, or any combination thereof, so that GUI parts provided by the framework such as sections 1106b-1106m may be displayed on a greater amount of space on the display 1102. Such functionality may result, for a particular native GUI, where that GUI is not sponsored. However, in an example where that native GUI is sponsored the hiding functionality may be turned off. The provider may charge the advertiser for turning off the hiding functionality for the particular GIU when the sponsor's ad is provided on that GUI. This too may be limited if an intrusiveness threshold is exceeded as determined by the analytics server. Even the GUI part 1104a may be integrated with the framework to use the hiding functionality according to sponsorship. See FIG. 12b for an example where the GUI part 1104a is hidden. In this case it is likely that the GUI part 1104a was not sponsored or the hiding function was not turned off for an additional fee.

The functionality of hiding GUI parts may occur when a user's finger, such as finger 1206 in FIG. 12b, interacts with a GUI part within a section provided by the framework, such as section 1106e. In an example, this functionality and other object movement is enhanced, in that movement and the hiding occurs seamlessly without unwanted visual artifacts, because the native operating system, the native client-side application, and the framework are closely coupled. Because of this coupling, the presentation sponsored affects may also occur without unwanted visual artifacts. For example, circuitry that controls such functionality can be a combination of circuitry of the native operating system, the native client-side application, and the framework, which exists in the host device, such as the mobile client device 1100 in FIGS. 11a-15b.

In an example, GUI parts provided by the framework may interact with GUI parts provided by the native client-side application and the native operating system. These interactions occur seamlessly because of the existence of associated circuitry being local to the client device displaying the GUI parts. Transitions between the various page views and section display changes are illustrated in FIGS. 11a-15b and FIGS. 15a-15b can occur without unwanted visual artifacts due to tight coupling between circuitry of the native operating system, the native client-side application, and the framework. For example, parts of the circuitry can include client-side code such as AJAX, JavaScript, or any combination thereof.

Alternatively or additionally, the framework may provide animations, including intentional visual artifacts, to provide a visually pleasing transition when transitioning from one displayed feature to another. In an example, even such transitions may be sponsored. With one or more of various animations, advertising may be integrated visually or even through audio output. For example, a semi-transparent layer with a logo ad may overlap the one or more animations in a transition. Also, when transitions are sponsored, such transitions may occur for an additional amount of time than if not sponsored. Further, advertising can be integrated with a theme for visual presentation of the GUI parts of the framework, such as a card theme. The card theme can include GUI sections that include boundaries with curved corners, and GUI sections that can overlap with each other to give the appearance that each section is a card with curved corners. See FIGS. 11a-15b. The transitions between various visual displays by the framework can include animations including rearranging of cards, such as shuffling of cards. During the rearrangement, one of the displayed cards in the shuffling could be an ad of a sponsor. Alternatively or additionally, the animations can include moving cards into and out of a deck of cards. The deck may include partial fanning in straight and/or rotational directions in a three dimensional graphical space. The animations for a transition can include fanning cards in a deck horizontally along an x-axis, vertically along a y-axis, in or out of the screen along a z-axis, rotationally around any one or combination of the x-, y-, z-axes, or any combination thereof. Likewise, during any of the aforementioned rearranging, one of the moving cards could include an ad.

FIG. 11a shows cards fanned out in a vertical direction along a y-axis relative to the display 1102. FIG. 11b shows one card drawn out of a deck of cards 1110 partially fanned out vertically. In a transition between the displaying of section 1106b to section 1106c, the fanned out cards of section 1106b may retract into the deck of cards 1110 displayed in section 1106c, vertically. The cards labeled “summary” and “more” of respective sections 1106c and 1106d in FIGS. 11b and 12a, when transitioning from one card to another may flash from one card to another. Between such flashes an ad may be flashed by a sponsor. Alternatively, transitions of such cards may include an animation including the card moving in and/or out of the deck of cards 1110. In an example, while the card is moving it may include an ad that is more visually perceivable while in motion. For example, a simple logo ad may appear on a card while it is in motion. The animation may also include a shuffling of the deck 1110. Animation with a shuffling of the deck 1110 may also occur when a search query occurs, such as the query entered into the search query box 1112. For example, when the framework transitions from providing information on Barrack Obama in FIGS. 11a-13b to providing information on Katie Bolmes in FIGS. 14a-14b, the deck of cards 1110 may shuffle to give the appearance that the deck of cards is being shuffled to find cards related to Katie Bolmes. An animation may also occur when a link or button is clicked that leads to a transition from one entity to another. Also, when a query is entered or at least partially entered, such an action may cause a transition from one entity to another.

Besides visual integration of an ad, a sponsored audio output associated with Katie Bolmes may occur during such transitions. For example, a recognizable song performed by Katie Bolmes may occur during the transition with directions on how to purchase the song. Like visual ads, intrusiveness of audio ads may be tracked, and future rendering of audio output may be affected by findings in the analysis of such tracked information. For example, the corresponding analysis can be used by the framework to change such advertising if intrusiveness of the audio ad exceeds an intrusiveness threshold. Audio and visual intrusiveness thresholds may be separate or combined. Also, the thresholds may be increased for a fee in some examples of the framework.

In an example, transitions within an entity may occur with relatively simple animations, such as flashing between cards, scrolling through related cards arranged side-by-side in a tray of cards in a single direction, or moving one or a few cards at least partially in and out of a deck, per user interaction with the respective entity GUI. Transitions from an entity to another entity may include relatively more complex animations, such as a shuffling of the deck of cards. In some examples, shuffling may occur either between transitions within an entity or from one entity to another. However, in such examples, the shuffling for transitions within an entity may occur for a noticeably less amount of time than the shuffling between entity changes. For example, shuffling due to transitions within an entity may be less than one second, and shuffling due to transitions between entities may be more than 2 seconds. These transition times may be increased for sponsored transitions. For example, such timing may be more than doubled when the transition is sponsored.

Also, in transitions between entities, the entities may bid on the transitions. Also, an alert to purchase a sponsored transition may be communicated to both entities if the transition occurs in an amount exceeding a threshold. This transition threshold may be adjusted, so that if it is found that sponsored transitions are having success, more alerts can be communicated. Also, like many other aspects of the framework, the adjustment of a threshold can be automated according to analytics periodically determined at the analytics server.

FIGS. 11a-15b show example screens of navigation of content, such as sponsored and non-sponsored content, emphasizing various features provided by the framework. One of these features may include the labeling or indication of when content is sponsored. In FIGS. 11a-15b, sponsorship is indicated by the label “ad” (e.g., see labels 1113, 1213a, 1213b, 1413, 1513a, and 1513b). In FIG. 11a, entity search results 1120 and 1122 are sponsored. Also, the indication of entity search results 1120 and 1122 being sponsored may indicate that at least part of the corresponding entity trays and their content are sponsored. In FIGS. 11a-13b and 15a, the backdrop 1130 includes the ad indicator 1113. In instances where a backdrop of an entity tray includes an ad indicator, at least part of the entity tray and its contents are sponsored.

In FIG. 12a, an entity location indicator image link 1201 and a scrollable miniature tray 1218b are sponsored. The sponsorship of content (such as an image link) and/or a sub-GUI (such as a scrollable miniature tray) can be by the same entity that has sponsored the at least part of the entity tray and its contents or a different sponsor, such as a partner of the tray sponsoring entity. In FIG. 12a, assuming OFA is the sponsor of the Barack Obama entity, a partner of OFA may sponsor content and/or sub-GUIs within the entity tray 1101a. Pricing for the sponsorship of sub-GUIs may be discounted for the entity or the partner. Although, Non-related entities may not receive a discount. Although, non-related entities may receive a discount of a particular type of content or sub-GUI that is sponsored globally across entities of the framework or a type of entity of the framework (such as a person entity, place entity, or thing entity). These types of discounts allow for the entity and others to share sponsorship costs within the entity tray, and the framework provider may increase revenue since more than one entity is sponsoring parts and/or content within an entity tray.

FIG. 11a, shows text “President” entered into a search query box 1112 via the virtual keyboard 1104b. In an example, the use of a capital letter, such as “P” in “President” may indicate that the search results are to include entity search results. In such an example, use of only lower case letters may indicate that the search results are not to include entity search results. Alternatively, the use of a capital letter in the search may indicate that the search results are only to include entity search results of the framework and no non-entity search results. In this alternative example, the use of no capital letters in the search may indicate that the search results are to include both entity and non-entity search results. In an example, where non-entity search results are included, search suggestions may be listed as well. Besides tactile input of text, text may be inputted through a voice command or some other form of user input. Use of capital letters is one way of indicating the type of search results desired in examples of the framework, but there may be other ways to indicate the desire to receive entity search results, non-entity search results, search suggestions, or any combination thereof. For example, through voice command entering of a search query a user may request verbally whether it is desired to receive entity search results, non-entity search results, search suggestions, or any combination thereof. For example, the user may input the voice command, “president only entity” to receive only entity search results for “Barack Obama”, or the user may input the voice command, “president mix” to receive a mix of search results (such as entity and non-entity search results) and suggestions for “president”. Additionally or alternatively, the user may input related icons, such as related emoticons, emoji, or kaomoji. Also, within the results there may be sponsored search results, non-sponsored search results, sponsored search suggestions, non-sponsored search suggestions, or any combination thereof. For example in FIG. 11a, search results 1120 and 1122 and search suggestion 1118a are sponsored.

In FIG. 11a, upon entering of “President” into the box or upon entering “President” and clicking on the search execution button 1114, search suggestions and/or search results can appear on the display 1102 within section 1106b. For example, upon entering “President” into the box 1112, but before clicking on the search execution button 1114, search topic suggestions may appear, such as the sponsored search suggestion 1118a. A user may select one of these suggestions, which causes execution of a query using the respective text displayed within the suggestion. In an example, where the suggestion is sponsored, results that occur from executing a search linked to the sponsored suggestion can be adapted to include at least one advertisement of the sponsor. Also, depending on a status of or fee paid by the sponsor that at least one advertisement may occur at the top and/or forefront of the results.

In FIGS. 11a-15b, the suggestions appear as cards. These suggestion cards may have a similar color and texture scheme, and the scheme may be simple, such as one solid color or a spectrum of colors within a range of a full spectrum of colors. For example, the suggestion cards may each be various shades of blue. Also, upon entering “President” into the box 1112, actual search results may appear, such as search results associated with a specific entity, such as a particular person, place, or thing. In this example, the entity search results include search results 1120, 1122, and 1124 in FIG. 11a. These results appear as cards too. These search result cards may have different color and texture schemes, and may include schemes associated with a photograph, such as a photograph bled out onto a card. This visual feature helps a user distinguish between a search result card, such as an entity search result card, and a search suggestion card (and optionally a non-entity search result card). Also, an entity search result can be visually distinguished from a set of non-entity search results, such as a set of webpage search results, by the color and texture scheme of the cards representing the entity results. For example, a simple one-color range theme may represent a set of webpage search results, whereas a more complex theme, such as a bled out photograph, may represent an entity search result. In FIG. 11a, entity search results 1120-1124 are visually distinguishable from each other and webpage based search result 1116. Also, sponsored entity search results are visually distinguishable from sponsored search suggestion 1118a. The non-sponsored web page results 1116 are not thematically distinguishable from the non-sponsored search suggestion 1118b. In examples, visual schemes may be different between sponsored suggestions, non-sponsored suggestions, sponsored non-entity search results, non-sponsored non-entity search results, sponsored entity search results, non-sponsored entity search results, or any combination thereof. For example, sponsored suggestions and sponsored search results may have color and/or texture schemes that are similar and more emphasized than non-sponsored suggestions and search results.

In the example shown in FIGS. 11a and 11b, a user may select one of the search results (such as entity search result 1120, 1122, or 1124) shown in FIG. 11a, which causes the page view to transition from displaying the fanned out search results and suggestions to a full-size card including information on the selected entity, such as shown in FIG. 11b. For example, a user may have selected the entity search result 1120, labeled with “Barack Hussein Obama—Politician”, resulting in the display of a full-size card for the entity, Barack Obama, the politician. A full-size card is a card that includes the graphical functionality of an entity tray. In other words, a full-size card may be a primary GUI for an entity tray.

Full-size entity cards, such as cards displayed for Barack Obama the politician (e.g., cards within sections 1106c-1106g in FIGS. 11b-13b), provide information specific to that entity or entities related to that entity. Besides a specific thing (such as a company), entities may include any particular person or place. For example, section 1106j in FIG. 15a depicts a place entity card for the favorite storefront location of Barack Obama. The full-size card in section 1106j is labeled “Green Can Coffee—Place” followed by an address of the location. This distinguishes this Green Can Coffee the place from other entity modules for locations of Green Can Coffee storefronts. Section 1106k in FIG. 15b depicts another thing entity (in particular, a product entity), for the entity Zbox. Sections 1106h and 1106i in FIGS. 14a and 14b, respectively, depict a person entity.

Various versions of Zbox may have their own full-size cards and entity trays, and although the depicted entity tray 1101 in FIG. 15b is not sponsored other aspects within the tray are sponsored. For example, the “more” card or “more” GUI 1502 is sponsored, which is indicated by the ad indicator 1513a. The thumbnail image link 1504 to a video of the Zbox is also sponsored, which is indicated by the ad indicator 1513b. In this sense, there is an expansive hierarchy and network of entities, and each of the online presented entities and graphical elements within these entities may be sponsored and monetized.

Within the expansive hierarchy and network, people, places, and things may have various types of relationships. For example, these relationships may include object relationships such as from the perspective of an object hierarchy including relationships between generic items and specific items, such as Zbox in general and specific versions of Zbox. This object hierarchy applies to places as well. For example, Green Can Coffee, may be a thing (a company) in general, but each location of Green Can Coffee is a specific place. The generic thing can be related the specific places, and such relationships may be outputted for user navigation through associated links, such as links to specific locations of Green Can Coffee 1306a and 1306b in FIG. 13b, which also may be favorite locations of entity Barack Obama the politician. Parent object sponsorship can be associated with children objects so that children objects are sponsored as well. Although, children objects may be sponsored by different entities as well.

Referring back to FIG. 11b, depicted is a full-size card 1126 for Barack Obama the politician. Within in the full-size card 1126, there are many parts viewable and hidden. Overlapping the full-size card are two sub-cards 1128a and 1128b, a card labeled “summary” and a card labeled “more”, respectively (hereinafter referred to as the summary card and the “more” card). These cards may be sponsored by the same entity that is sponsoring the entity tray 1101a, as indicated by ad indicator 1113. The full-size card 1126 and the two sub-cards 1128a and 1128b are extended out from the deck of cards 1110. Also, the deck of cards 1110 is not sponsored independently, but may be sponsored by the same entity that is sponsoring the entity tray 1101a, as indicated by ad indicator 1113. Sub-cards of a deck of cards or the deck of cards itself may each be independently sponsored, although this is not the case in FIGS. 11a-15a.

The section 1106c, which includes the deck of cards 1110 and cards extended out from the deck, can also be referred to as an entity tray. The section 1106b overlapped by the virtual keyboard 1104b may also encompass a tray 1103 for at least cards 1116-1124. A tray can be associated with at least a partially executed search query and/or an unexecuted search query. For example, section 1106b may encompass a tray associated with unexecuted search queries including the search term “President”, such as search suggestions. Sections 1106c-1106g encompass a tray 1101a associated with the searched entity, Barack Obama the politician, which is at least a partially executed search query.

In summary, section 1106b encompasses the tray 1103, which includes sponsored and non-sponsored search results and suggestions associated with text “President” entered in search box 1112. Sections 1106c-1106g encompass a tray 1101a associated with the searched entity Barack Obama the politician. The entity tray 1101a is sponsored as indicated by the ad indicator 1113. Sections 1106h and 1106i encompass a tray 1101b associated with the searched entity Katie Bolmes the actress. The entity tray 1101b is sponsored as indicated by ad indicator 1413 in FIG. 14a. Section 1106j encompasses a tray 1101c associated with the searched entity Green Can Coffee a place entity at a specific location of a Green Can Coffee storefront. The entity tray 1101c is sponsored as indicated by ad indicator 1513c in FIG. 15a. Section 1106k encompasses a tray 1101d associated with the searched entity, Zbox, a thing entity.

The content within entity tray, such as entity tray 1101a, may be or include content dynamically resulting from individual sub-queries. In this sense, an entity tray can be a presentation of search results arranged in a more intuitive and pleasing manner than a mere list of search results. The searched results in an entity can be selectively arranged and presented in a manner similar to arrangements of content within a print or online textbook, magazine, newspaper, or any combination thereof; instead of arranged as a search results list. Also, such arrangements can have graphical themes, such as the illustrated card theme in FIGS. 11a-15b.

Also, within an entity tray, presentations associated with at least one module circuitry may appear. Each module has respectively circuitry configured to execute various aspects of the module. In FIG. 11b, depicted is a GUI rendered by an entity summary module. This summary GUI and other GUIs within the tray, can include searched and dynamically generated summary information regarding the selected entity. Also, through data feeds or information management tools, an entity managing the tray (such as the framework provider or sponsor of the tray) can select and supply information to the GUIs of the tray, such as office hours, business locations, phone numbers, recent promotions, coupons, application links to their applications at an online application store, and links of extended information such as ratings, reviews, check-in information, images, products sold, and the like. Also, parts of such information may be scraped or indexed and collected by a web crawler.

In FIG. 11b, the selected entity is Barack Obama the politician. The information that appears in the summary GUI may be scraped information, information retrieved from a web crawler and indexed, information from a content database, information selected by a party that is responsible for editing the information, information selected by machine learning, or any combination thereof. Such information may be mined by and/or from any one or more of the servers and databases illustrated in FIG. 1. Such information may include most sought out information for the selected entity. Most sought out information may be determined from online search logs and other logs pertaining to web browsing, by an analytics server (such as the analytics server 118). The information may be updated in various intervals. The length of time between updates may be based on an amount the entity summary is requested for the selected entity. The information within the entity summary may be plain text or hypertext that links to other entities or initiates a search related to the hypertext when the hypertext is selected. The information presented in the summary GUI may be sponsored, non-sponsored, or both. The summary module circuitry associated with the summary GUI may include sub-circuitry specific to sponsored aspects and non-sponsored aspects of the summary GUI. Also, the tray module circuitry associated with the control and display of trays may include sub-circuitry specific to sponsored aspects and non-sponsored aspects of entity trays.

Also, as illustrated in FIG. 11b, the summary information may include applications, such as widgets 1134a and 1134b. Widget 1134a includes a poll ticker for Barack Obama the politician. Widget 1134b includes a link to an application that can locate favorite locations of Barack Obama the politician. For example, a user may click on the widget 1134b, which causes a transition from the summary GUI to an entity locator application GUI, such as a maps card 1304 illustrated in FIG. 13b. The respective module circuitry associated to the control and display of each of these applications may include sub-circuitry specific to sponsored aspects and non-sponsored aspects of these applications. Additionally or alternatively, the summary information may include social media widgets and information, such as social media widget 1134d of FIG. 11b and the information provided by the widget. The social media widget 1134d may present what one or more of a user's friends think of the entity being summarized by the summary information.

Besides summary information including a widget other entity information and GUIs may include widgets, such as social media widgets. For example, the entity tray 1101a includes social media widget 1134c (see FIGS. 11a-13b), which presents the amount of friends linked to the user through social media that have viewed the entity tray of Barack Obama the politician. The entity tray 1101b in FIGS. 14a and 14b has a similar widget 1134f for Katie Bolmes the person. The entity tray 1101c in FIG. 15a has a similar widget 1134g, for Green Can Coffee the place at 100 W Adams Street. The entity tray 1101d in FIG. 15b has a different type of social media widget, social media widget 1134i, which presents a cumulative rating of all user ratings of the entity Zbox the thing, across one or more social media sources. Also, the entity tray 1101c has a second social media ratings widget 1134h. This widget has a cumulative rating of all ratings made by friends of the user for the Green Can Coffee at 100 W Adams Street, across one or more social media sources. Also, in FIG. 13b, the map in the map card 1304 may include social media graphical elements as well. For example, on the map in the map card 1304 indicating Green Can Coffee locations, the map also includes an indicator 1134e of a restaurant that a friend of the user reviewed. In FIG. 12a, the miniature tray 1218c is partially provided by a social media module circuit. In this sense, the miniature tray 1218c may also be considered a social media widget presenting social media information, such as things the user's friends search that are related to Barack Obama and/or Green Can Coffee.

Depicted in FIG. 11b, a theme may be rendered by an entity theme module circuit. The entity theme module circuitry may include visual and instrumental settings for the tray associated with the selected entity. For example, trays can look, feel, and operate differently. Such settings may include setting for the backdrop of the tray. A backdrop may include a photograph associated with the entity, such as a photograph including the entity, fitted to a section encompassing the tray. FIGS. 11b-13b show at least part of the backdrop 1130 for the entity Barack Obama the politician. The backdrop 1130 includes a label 1132a for the entity Barack Obama the politician and a photo image associated with Barack Obama 1132b. See FIG. 11b. Besides the tray for Barack Obama the politician, the search result card for Barack Obama the politician includes part of the backdrop 1130 (See FIG. 11a). Also, the backdrop can be modified by the backdrop module circuitry. The theme module circuitry may include circuitry that supports visual schemes (such as color and texture schemes) for various aspects of the framework, including schemes for entity trays and sub-GUIs of entity trays. The theme module circuitry may include sub-circuitry specific to sponsored aspects and non-sponsored theme aspects of the framework. Also, the backdrop module circuitry may include sub-circuitry specific to sponsored aspects and non-sponsored aspects of the backdrop.

At the screen in FIG. 11b, a user can select the tab associated with the “more” card 1128b. This may cause the tray for Barack Obama the politician to transition from the summary card 1128a to the “more” card 1128b. The displaying of the “more” card 1128b is illustrated in FIG. 12a. The “more” card 1128b includes a GUI rendered by a “more” module circuit. This “more” GUI includes information regarding the selected entity. As depicted, the information of the “more” GUI can be displayed through sub-GUIs associated with different categories and modules circuits associated with the different categories. Each sub-GUI can be rendered by one or more related module circuitry. The “more” module circuitry can include configuration information, such as presentation configuration information for the module and sub-modules within the module. For example, in the FIG. 12a, some sub-modules are presented as scrollable miniature trays 1218a-1218c with respective miniature cards displayed side-by-side. For example, in the touchscreen context miniature cards within a miniature tray can be cycled through by swiping the tray in a corresponding direction.

The “more” module circuitry can also include configuration information relevant to which sub-module GUIs to include with the “more” module GUI. For example, in FIG. 12a, at least sub-modules circuits for displaying nearest locations of Barack Obama's favorite locations, famous people that endorse Barack Obama, and other things search by people that search Barack Obama have been selected to be included with the “more” module circuitry for Barack Obama the politician. The “more” module circuitry for Barack Obama the politician can be a combination of the “more” module circuitry and entity circuitry for Barack Obama the politician, in communication with each other. The selection of sub-module circuitry per module circuitry may be global across all entities, particular per entity type, particular per entity, or any combination thereof. For example, in the “more” module circuitry, the “nearest locations” module circuitry may be included across thing entities with storefronts. Whereas, for example, “images” module sub-GUI (as shown displayed in FIG. 12b as the sub-GUI 1208) may be universally selected across all types of entities. The “Famous fans” module sub-GUI may be included just for the instance of the “more” module GUI for Barack Obama the politician or any other politician entities.

The “more” module circuitry may include circuitry that supports the “more” GUI and related control of the “more” module. The “more” module circuitry may include sub-circuitry specific to sponsored aspects and non-sponsored aspects of the “more” GUI and related control of the “more” module.

The selection of sub-modules GUIs may be based on various sources. For example, the sponsor of an entity module may select one or more of the sub-module GUIs per GUI of the entity tray. Additionally or alternatively, selected modules may be based on scraped online information, information retrieved from a web crawler and indexed, information from a content database, information selected by a party that is responsible for editing the corresponding entity tray, information selected by machine learning, or any combination thereof. Such information may be mined by and/or from any one or more of the servers and databases illustrated in FIG. 1. Such information may include most sought out information for the selected entity. The most sought out information may be related to most common categories searched along with queries for a particular entity. For example, search logs may show it is likely that the intent of users querying for information on Green Can Coffee are also looking for information on locations of Green Can Coffee storefronts. Also, as mentioned, an owner, such as an owner advertiser, associated with the Green Can Coffee, may manually select the sub-module GUIs to include with a particular module GUI, such as the “more” module GUI.

There are benefits to using machine learning to predict intentions of users querying an entity and using the predictions to select sub-modules for that module circuitry. Actually, various aspects of an entity tray may be determined based on such predicted intentions of users searching for the entity associated with the entity tray. For example, machine learning can be used to determine predicted information and information desired by the user to be displayed anywhere on an entity GUI. Such information can be determined according to historical online user interaction data that can include data pertaining to clicks, searches, dwell times, or any combination thereof. Respective module circuitry associated with such predictions may include respective specific circuitry for predictions with related to sponsored content and non-sponsored content.

In FIG. 12a, the selected entity is still Barack Obama the politician. The information that appears in the “more” GUI may be scraped information, information retrieved from a web crawler and indexed, information from a content database, information selected by a party that is responsible for editing the information, information selected by machine learning, or any combination thereof. Such information may be mined by and/or from any one or more of the servers and databases illustrated in FIG. 1. Such information may include most sought out categorical information and detailed information pertaining to each category for the entity. This most sought out information may be determined from online search logs and other logs pertaining to web browsing, by an analytics server (such as the analytics server 118). The categorical information and the detailed information may be updated in various intervals. The length of time between updates to each sub-GUI may be based on an amount that sub-GUI is requested for the selected entity. The information within the entity GUIs may be images and/or text and may include hyperlinks to other entities or hyperlinks that initiate related searches. For example, a user may select one of the storefront location images in the entity location indicator 1201, and this may initiate a search with respect to the selected storefront or navigation to an entity tray for that storefront if it exists within the framework, such as the entity tray 1101c in FIG. 15a.

Also, as depicted, a user may select one of the image based links in the “famous fans” sub-GUI 1203 or the “things search by your friends that you may like” sub-GUI 1205, and this may initiate a search with respect to the selected link or navigation to an entity tray linked to the selected image based link. The links in the sub-GUI 1205 may be provided by social media sources. For example, a user may select one of the images associated with one of the endorsers of Barack Obama, such as the image labeled “Katie Bolmes” 1202 that includes an ad indicator 1213b. This may cause the GUI of the framework to swap out the tray 1101a for Barack Obama the politician with the tray 1101b illustrated in FIGS. 14a and 14b for Katie Bolmes the actress. FIG. 14a includes a summary card for Katie Bolmes the actress rendered on the backdrop of the tray 1101b. In an example of the framework, the default landing page or sub-card of a tray is the summary GUI. Also, depicted in FIG. 14a is a change in the label of the deck of cards to “All search results for Katie Bolmes” instead of “All search results for Barack Obama”. Also, the text in the search box 1112 may be changed automatically to text associated with the destination entity. In this case, the navigation from the Barack Obama tray 1101a to the Katie Bolmes tray 1101b causes a change in the label on the deck of cards and a change of the text in the search box to text including Katie Bolmes.

In FIG. 14b, a text string “Favorite Color” has been entered into the search box along with “Katie Bolmes”. This additional text may be predicted to be a question associated with entity predicted for the search text. In this case, the framework is predicting, through a question prediction module, that the user is interested in the favorite color of Katie Bolmes the actress. The question prediction module circuitry may be coupled with question answering module circuitry configured to search out an answer to the predicted question. In FIG. 14b, it is shown that the question answering module circuitry is configured to output an answer 1402 to a position for answers 1404 at the top of the summary card for Katie Bolmes. The question prediction module circuitry may include sub-circuitry specific to sponsored aspects and non-sponsored aspects associated with question prediction in the framework. The question answering module circuitry may include sub-circuitry specific to sponsored aspects and non-sponsored aspects associated with question answering in the framework. As it is depicted in FIG. 14b, the position for answers 1404 is sponsored. Where the position for answers is sponsored, the area of the position may take on graphical themes and elements associated with the sponsor.

Referring back to FIG. 12a, a user may select the deck of cards 1110, such as by clicking on or swiping upwards beginning at the text “All search Results for Barack Obama”. This may cause the tray 1101a for Barack Obama the politician to transition from the “more” card 1128b to the “all search results” card 1204 in FIG. 12b. The displaying of the “all search results” card 1204 is illustrated in FIG. 12b. The “all search results” card 1204 includes a GUI rendered by an “all search results” module circuitry. This “all search results” GUI includes information regarding the selected entity. As depicted, information of the “all search results” GUI can be displayed through sub-GUIs associated with different categories, and module circuitry associated with the different categories. Each sub-GUI can be rendered by one or more related module circuitry. The “all search results” module circuitry can include configuration information, such as presentation configuration information for the module circuitry and sub-modules within the module circuitry. For example, in the FIG. 12b, the images sub-GUI is presented as a scrollable miniature tray with respective miniature cards displayed side-by-side, each card including an image of the entity associated with the tray 1101a for Barack Obama the politician. The “webpage results” sub-module is presented as a scrollable miniature tray with a listing of webpage based search results. These search results may be clickable to navigate to a corresponding webpage or another card associated with the entity tray. In FIG. 12b, depicted is a user's finger 1206 gesturing over the webpage search results provided by the webpage results sub-module circuitry. Upon such a gesture, sections 1108a and 1106a have been hidden to allow more screen space to display the webpage search results.

The “all search results” module can also include configuration information relevant to which sub-modules to include with the “all search results” module. For example, in FIG. 12b, at least sub-modules for webpage search results and image search results have been selected to be included with the “all search results” module for Barack Obama the politician. As mentioned, the selection of sub-modules per module may be global across all entities, particular per entity type, particular per entity, or any combination thereof. For example, in the “all search results” module, the “images” module may be included across people and thing entities but not places entities. Whereas, for example, “webpage results” module (as shown displayed in FIG. 12b as the sub-GUI 1210) may be universally selected across all types of entities for the “all search results” module. It should be noted for the “all search results” module circuitry as well as other module circuitry with GUIs depicted herein, that associated sub-GUIs may be hidden from the illustrated views, but may become viewable upon scrolling through respective sections.

Also, the “all search results” module circuitry may include circuitry that supports the “all search results” GUI and related control of the “all search results” module. The “all search results” module circuitry may include sub-circuitry specific to sponsored aspects and non-sponsored aspects of the “all search results” GUI and related control of the “all search results” module.

In FIG. 12b, the selected entity is still Barack Obama the politician, and a user may select a link, such as image link 1212 or text link 1214. Selecting a link, such as image link 1212, may cause the client-side application to navigate to a webpage associated with a website hosting the corresponding image. Alternatively, it may cause the client-side application to navigate to a card within the tray of the entity, such as a card 1302 for an image slideshow module (as depicted in FIG. 13a). As illustrated in FIG. 13a, images within the image slideshow may be sponsored (e.g., see image indicator 1313a). Selecting a text link, such as text link 1214, may cause the client-side application to navigate to a webpage corresponding with that link. Alternatively, selecting a text link, such as text link 1214, may cause the client-side application to navigate to a card, such as the maps card 1304 within the tray of the entity (as depicted in FIG. 13b). The maps card or similar framework interfaces may be labeled according to the context associated with the entity. For example, since Barack Obama has favorite locations, the map card for this entity is labeled “Obama Favorites”. In FIG. 15b, the depicted map is labeled “places to buy Zbox”, since Zbox is a product. The information within GUIs of the framework may be images and/or text and may include hyperlinks to other cards within the entity tray, other entities, or may initiate related searches. All or any of which may be sponsored.

In FIG. 13b, the maps card 1304 marks locations of Green Can Coffee storefronts, which also happen to be favorite locations of Barrack Obama. The map can be adjusted and maneuvered to find additional locations not first presented by the map. Below the map is a list of the locations identified on the map. In the list, a location may be sponsored, such as indicated by the ad indicator 1313b. Other aspects of the map card may also be sponsored, such as the zip code entry tool (see the ad indicator 1313c). When a user enters a zip code into the tool the map card may refresh with locations of the entity within that zip code. Tools, such as the zip code entry tool may be universal across most entities for certain sub-GUIs and may have one or a set of rotating sponsors. For example, the provider of the network could target navigation technology companies for sponsorship of the zip code tool across the framework.

In the list of locations on the maps card 1304, links to places entities may be presented, such as links 1306a and 1306b. For example, a user may select one of the links associated with a place entity for Green Can Coffee at a particular storefront, such as link 1306b. This may cause the GUI of the framework to swap out the tray 1101a for Green Can Coffee the thing with the tray 1101c illustrated in FIG. 15a for Green Can Coffee the place at a specific location (e.g., see entity tray 1101c, which is labeled “Green Can Coffee the storefront at 100 W Adams Street”). FIG. 15a includes a summary card for the specific storefront of Green Can Coffee, which includes, with respect to the particular location, an indication of its location on a map, its address, amount of time until closing, an overall rating of the place by customers, and a phone number. The backdrop includes the label for the entity, its address, and hours open.

Referring back to FIG. 12b, the information that appears in the “all search results” GUI may be scraped information, information retrieved from a web crawler and indexed, information from a content database, information selected by a party that is responsible for editing the information, information selected by machine learning, or any combination thereof. Such information may be mined by and/or from any one or more of the servers and databases illustrated in FIG. 1. Also, the search results displayed by the “all search results” GUI may be determined by various known and foreseeable search engine algorithms. The search results may include most sought out information for the selected entity per category associated with the presented sub-GUIs. This most sought out information may be determined from online search logs and other logs pertaining to web browsing, by an analytics server (such as the analytics server 118). The categorical information and the search results may be updated in various intervals. The length of time between updates to each search result sub-GUI may be based on an amount that sub-GUI is requested for the selected entity.

To navigate back from card 1302 in FIG. 13a or card 1304 in FIG. 13b, a user may make a certain gesture towards the section 1106f or 1106g, respectively. In one example, a user may swipe downward starting at the top of the card to move that card downward, showing the sections of the tray 1101a that have been overlapped by the card. For example, using a gesture to move down the card 1302, may cause the presentation illustrated in FIG. 11b, FIG. 12a, or any other previously displayed card for that entity, such as the last card displayed for that entity prior to the card being moved downward. In other words, this functionality may act similar to a back button. To navigate to a new entity, the user may select a link to another entity or enter a new query in the search box 1112 along with other actions. For example, upon entering text in the search box 1112, the framework may cause the client device 1100 to display search suggestions and/or search results similar to those depicted in section 1106b of FIG. 11a except the suggestions and/or results pertain to the newly entered text. Then a user may select another entity from the listing.

1. A system stored in a non-transitory device executable by processor circuitry, comprising:
a receiver configured to receive a search query from an advertiser device, the search query including one or more words;
an entity search engine device configured to:
execute the search query on an entity search database, the execution including identifying one or more word entries of a plurality of word and word combination entries stored in the entity search database that match the search query, the entity search database including:
a word data structure containing the plurality of word and word combination entries; and
an entity data structure containing a plurality of entity object entries, the plurality of word and word combination entries linking to the plurality of entity object entries according to manually generated links, automatically generated links, or both; and
communicate to the advertiser device one or more entity object identifications associated with one or more entity entries of the plurality of entity object entries, wherein the one or more entity entries link to the identified one or more word entries.

2. The system of claim 1, wherein the automatically generated links are generated according to correlations determined from analytics data.

3. The system of claim 1, wherein manual generation of the manually generated links includes providing an opportunity for the advertiser to bid on the linking the one or more entity entries to the identified one or more word entries.

4. The system of claim 1, wherein the entity search engine device is further configured to identify whether a bid on the search query includes a request to promote a sponsored search result associated with the search query and the bid.

5. The system of claim 1, wherein the match occurs due to: the search query and a word or a word combination of the plurality of word and word combination entries having a same word or words, irrespective of order of the words; the search query and a word or word combination of the plurality of word and word combination entries having a substantially similar word or words; or both.

6. A system stored in a non-transitory device executable by processor circuitry, comprising:
first graphical user interface (GUI) circuitry configured to output entity object information, the entity object information including an entity title and an entity sponsor associated with an entity object;
second GUI circuitry configured to output at least one word or word combination linked to the entity object;
third GUI circuitry configured to:
output a first input field configured to receive a search term, the search term including the at least one word or word combination; and
output a second input field configured to receive a bid amount for the search term; and
fourth GUI circuitry configured to communicate the search term and the bid amount to the system.

7. The system of claim 6, further comprising fifth GUI circuitry configured to output at least one suggested word or word combination for linking to the entity object.

8. The system of claim 7, wherein the fifth GUI circuitry is further configured to output an indication of an exclusivity right for the at least one suggested word or word combination and a corresponding suggested cost for the exclusivity right.

9. The system of claim 6, wherein the second GUI circuitry is further configured to output an indication of an exclusivity right for the at least one word or word combination and a corresponding cost for the exclusivity right.

10. The system of claim 6, wherein the bid amount, the search term, or both are received from a voice command input, a keyboard input, a keypad input, or a gesture selection input on the bid amount, search term, or both.

11. The system of claim 6, wherein the third GUI circuitry is further configured to output a third input field configured to receive a bid amount for increasing a probability that a search result associated with the search term is perceived.

12. The system of claim 6, wherein the third GUI circuitry is further configured to output an exclusivity bid amount upon receiving the search term, the exclusivity bid amount being an amount required to generate an exclusive link to the search term from the entity object.

13. The system of claim 6, wherein the third GUI circuitry is further configured to receive a request for an exclusive link to the search term from the entity object, and wherein the fourth GUI circuitry is further configured to communicate the request to the system.

14. The system of claim 6, further comprising fifth GUI circuitry configured to output an input field configured to receive an additional bid amount for the search term that leads to a conversion of ad content to an entity tray of the entity object.

15. A system stored in a non-transitory device executable by processor circuitry, comprising:
first graphical user interface (GUI) circuitry configured to output an advertiser name of an advertiser;
second GUI circuitry configured to output one or more search terms sponsored by the advertiser;
third GUI circuitry configured to output one or more suggested entities associated with the one or more sponsored search terms;
fourth GUI circuitry configured to:
output a first input field configured to receive a search term of the one or more sponsored search terms;
output a second input field configured to receive an entity name of an entity associated with an entity object of the one or more suggested entities;
output a third input field configured to:
receive a link request to link the search term and the entity; and
send the link request to the system, wherein link circuitry of the system is configured to determine whether to generate a corresponding link.

16. The system of claim 15, wherein the search term includes one or more words.

17. The system of claim 15, wherein the search term is received from a voice command input, a keyboard input, or a keypad input.

18. The system of claim 15, wherein the fourth GUI circuitry is further configured to output a fourth input field configured to receive a bid amount for further emphasizing a search result associated with the search term.

19. The system of claim 18, wherein the further emphasis includes changing positioning of the search result to increase a probability that the search result is perceived.

20. They system of claim 15, wherein the fourth GUI circuitry is further configured to output a fourth input field configured to:
receive an exclusivity request for an exclusive link to the search term from the entity object; and
send the exclusivity request to the system.
